(19) United States
(12) Patent Application Publication
(10) Pub. No.: US 2023/0066071 A1
(43) Pub. Date: Mar. 2, 2023

(54) IMAGE CORRECTION METHOD AND IMAGE CORRECTION SYSTEM

(71) Applicant: Semiconductor Energy Laboratory Co., Ltd., Atsugi-shi (JP)

(72) Inventors: Yusuke KOUMURA, Atsugi (JP); Yuki OKAMOTO, Ebina (JP); Toshiki MIZUGUCHI, Atsugi (JP); Tatsuya ONUKI, Atsugi (JP); Hideki UOCHI, Atsugi (JP)

(21) Appl. No.: 17/894,261

(22) Filed: Aug. 24, 2022

(30) Foreign Application Priority Data
Sep. 2, 2021 (JP) 2021-143124

(51) Int. Cl. G09G 3/20; G09G 3/3233

(52) U.S. Cl. CPC G09G 3/2007; G09G 3/3233; G09G 2300/0842; G09G 2360/16; G09G 2320/0626; G09G 2330/021; G09G 2320/0666

(57) ABSTRACT

A novel image correction system is provided. The image correction system includes an imaging device, a first arithmetic device, a display portion including a plurality of pixels, and a second arithmetic device. The imaging device obtains imaging data by capturing a first-gray-level image displayed on the display portion. The first arithmetic device calculates the luminous intensity of each of the pixels and a correction standard by using the imaging data. The first arithmetic device calculates correction data for each of the pixels by using the luminous intensity and the correction standard. The second arithmetic device corrects a video signal by using the correction data. The display portion displays an image using the corrected video signal. The first arithmetic device calculates correction data for pixels that emit red light, pixels that emit green light, and pixels that emit blue light and modifies the correction data by using color temperature data.

### BACKGROUND OF THE INVENTION

### 1. Field of the Invention

One embodiment of the present invention relates to an image correction method and an image correction system.

Note that one embodiment of the present invention is not limited to the above technical field. Examples of the technical field of one embodiment of the present invention disclosed in this specification and the like include a semiconductor device, a display device, a light-emitting device, a power storage device, a memory device, an electronic device, a lighting device, an input device, an input/output device, a driving method thereof, and a manufacturing method thereof.

### 2. Description of the Related Art

An active-matrix display device where a transistor for driving a display element is provided in each pixel of the display device is known. For example, an active-matrix liquid crystal display device that includes a liquid crystal element as a display element, an active-matrix light-emitting display device that includes a light-emitting element, such as an organic EL element, as a display element, and the like are known.

To increase the display quality of a display device, a variety of methods for correcting image data have been proposed. For example, Patent Document 1 discloses a configuration in which an image displayed on a display portion is captured by an imaging device to produce correction data and the correction data is used to make unevenness of the displayed image inconspicuous.

In display devices for televisions and monitors, display devices for smartphones and tablet terminals, and the like, an increase in definition (the number of pixels) has been required in recent years. In particular, high-definition display devices have been required for virtual reality (VR) or augmented reality (AR) display devices.

### REFERENCE

[Patent Document 1] Japanese Published Patent Application No. H7-261719

### SUMMARY OF THE INVENTION

In general, a pixel in a display device that performs full-color display includes a subpixel that emits red light, a subpixel that emits green light, and a subpixel that emits blue light. Display elements and pixel circuits for driving the display elements are fabricated through a complicated process and thus are likely to have variations in characteristics. To increase the display quality of the display device, variations in characteristics among the subpixels need to be corrected.

When the definition of the display device increases, the display device is likely to be affected by variations in characteristics of transistors included in pixels and variations in characteristics of display elements; hence, a decrease in display quality, such as display unevenness, is likely to be recognized in some cases.

An object of one embodiment of the present invention is to provide an image correction system that improves the display quality of a display device. Another object of one embodiment of the present invention is to provide an image correction method for improving the display quality of a display device. Another object of one embodiment of the present invention is to provide a novel image correction system. Another object of one embodiment of the present invention is to provide a novel image correction method.

Note that the description of these objects does not preclude the existence of other objects. One embodiment of the present invention does not necessarily achieve all the objects listed above. Objects other than these can be derived from the description of the specification, the drawings, the claims, and the like.

One embodiment of the present invention is an image correction method for a display device including a plurality of pixels arranged in a matrix. The image correction method includes a first step of obtaining luminance distribution of an image displayed with a first gray level; a second step of determining a position and an area of each of the plurality of pixels, by using the luminance distribution; a third step of calculating a luminous intensity of each of the plurality of pixels, by using the luminance distribution; a fourth step of determining a correction standard by using the luminous intensity of each of the plurality of pixels; a fifth step of generating correction data by using the correction standard and the luminous intensity of each of the plurality of pixels; a sixth step of storing the correction data in a memory device; and a seventh step of correcting a video signal to be supplied to each of the plurality of pixels, by using the correction data stored in the memory device.

Another embodiment of the present invention is an image correction system including an imaging device, a first arithmetic device, a display portion including a plurality of pixels, and a second arithmetic device. The imaging device has a function of obtaining luminance distribution by capturing a first-gray-level image displayed on the display portion. The first arithmetic device has a function of calculating a luminous intensity of each of the plurality of pixels by using the luminance distribution, a function of calculating a correction standard by using the luminance distribution, and a function of calculating correction data for each of the plurality of pixels by using the luminous intensity of each of the plurality of pixels and the correction standard. The second arithmetic device has a function of correcting a video signal for displaying an image on the display portion, by using the correction data.

The correction standard may be, for example, a maximum value, an average value, or a median value of the luminous intensities of the plurality of pixels. Alternatively, a given luminous intensity may be set as the correction standard.

The image correction system according to one embodiment of the present invention may include a first memory device and a second memory device. For example, the first memory device may have a function of storing imaging data, and the second memory device may have a function of storing the correction data.

Another embodiment of the present invention is an image correction system including an imaging device, a first arithmetic device, a display portion, and a second arithmetic device. The display portion include a plurality of first pixels that emit first light, a plurality of second pixels that emit second light, and a plurality of third pixels that emit third light. The imaging device has a function of obtaining luminance distribution by capturing a first-gray-level image displayed on the display portion. The first arithmetic device has a function of calculating a luminous intensity of each of the first pixels, a function of calculating a first correction standard, a function of calculating a luminous intensity of each of the second pixels, a function of calculating a second correction standard, a function of calculating a luminous intensity of each of the third pixels, and a function of calculating a third correction standard, by using the luminance distribution. The first arithmetic device has a function of calculating first correction data for each of the first pixels by using the luminous intensity of each of the first pixels and the first correction standard, a function of calculating second correction data for each of the second pixels by using the luminous intensity of each of the second pixels and the second correction standard, and a function of calculating third correction data for each of the third pixels by using the luminous intensity of each of the third pixels and the third correction standard. The second arithmetic device has a function of correcting a video signal for displaying an image on the display portion, by using the first correction data, the second correction data, and the third correction data.

The first correction standard may be, for example, a maximum value, an average value, or a median value of the luminous intensities of the first pixels. The second correction standard may be, for example, a maximum value, an average value, or a median value of the luminous intensities of the second pixels. The third correction standard may be, for example, a maximum value, an average value, or a median value of the luminous intensities of the third pixels. A given luminous intensity may be set as each of the first to third correction standards.

The image correction system according to one embodiment of the present invention may include a first memory device and a second memory device. For example, the first memory device may have a function of storing imaging data, and the second memory device may have a function of storing the first to third correction data.

The first light is red light, for example; the second light is green light, for example; and the third light is blue light, for example.

The first arithmetic device may have a function of adjusting white balance so that an image to be displayed on the display portion has a given color temperature, by adjusting values of the first correction data, the second correction data, and the third correction data.

One embodiment of the present invention can provide an image correction system that improves the display quality of a display device. Another object of one embodiment of the present invention can provide an image correction method for improving the display quality of a display device. Another embodiment of the present invention can provide a novel image correction system. Another embodiment of the present invention can provide a novel image correction method.

### BRIEF DESCRIPTION OF THE DRAWINGS

In the accompanying drawings:

FIG. 1 is a block diagram illustrating a configuration example of an image correction system;

FIGS. 2A and 2B illustrate arrangement examples of a display portion and an imaging device;

FIG. 3 is a flow chart showing a method for generating correction data;

FIG. 4A illustrates luminance distribution of imaging data, and FIG. 4B illustrates a luminance profile of a subpixel;

FIG. 5 is a flow chart showing a method for correcting a video signal;

FIGS. 6A and 6B each illustrate luminance of three subpixels;

FIG. 7 is a flow chart showing a method for adjusting correction data;

FIGS. 8A to 8C illustrate a structure example of a display device;

FIGS. 9A to 9F illustrate structure examples of pixels;

FIG. 10 illustrates a structure example of a display device;

FIGS. 11A and 11B illustrate a structure example of a display device;

FIGS. 12A and 12B illustrate circuit configuration examples of a pixel;

FIGS. 13A to 13F each illustrate a structure example of a light-emitting device;

FIGS. 14A and 14B are visualized images of luminance distribution;

FIGS. 15A and 15B are visualized images of luminance distribution; and

FIG. 16 is a histogram showing luminance variations.

### DETAILED DESCRIPTION OF THE INVENTION

Embodiments will be described below with reference to the drawings. Note that the embodiments can be implemented with various modes, and it will be readily appreciated by those skilled in the art that modes and details can be changed in various ways without departing from the spirit and scope of the present invention. Therefore, the present invention should not be construed as being limited to the description of the embodiments below.

In this specification and the like, a semiconductor device refers to a device that utilizes semiconductor characteristics, and means a circuit including a semiconductor element (e.g., a transistor, a diode, or a photodiode), a device including the circuit, and the like. The semiconductor device also means devices that can function by utilizing semiconductor characteristics. For example, an integrated circuit, a chip including an integrated circuit, and an electronic component including a chip in a package are examples of the semiconductor device. In some cases, a memory device, a display device, a light-emitting device, a lighting device, an electronic device, and the like themselves are semiconductor devices and also include a semiconductor device.

Ordinal numbers such as “first”, “second”, and “third” in this specification and the like are used in order to avoid confusion among components. Thus, the terms do not limit the number of components. The terms do not limit the order of components, either. For example, a “first” component in one embodiment in this specification and the like can be referred to as a “second” component in other embodiments, claims, or the like. As another example, a “first” component in one embodiment in this specification and the like can be omitted in other embodiments, claims, or the like.

In this specification and the like, terms for describing arrangement, such as “over”, “under”, “above”, and “below”, are sometimes used for convenience to describe the positional relation between components with reference to drawings. Furthermore, the positional relation between components changes as appropriate in accordance with the direction in which each component is described. Thus, the positional relation is not limited to that described with a term used in this specification and the like and can be explained with another term as appropriate depending on the situation. For example, the expression “an insulator over (on) a top surface of a conductor” can be replaced with the expression “an insulator on a bottom surface of a conductor” when the direction of a diagram showing these components is rotated by 180°.

The term “over” or “below” does not necessarily mean that a component is placed directly on or directly under and directly in contact with another component. For example, the expression “electrode B over insulating layer A” does not necessarily mean that the electrode B is on and in direct contact with the insulating layer A, and can mean the case in which another component is provided between the insulating layer A and the electrode B.

The term “overlap”, for example, in this specification and the like does not limit a state such as the stacking order of components. For example, the expression “electrode B overlapping with insulating layer A” does not necessarily mean the state where the electrode B is formed over the insulating layer A, and includes the case where the electrode B is formed under the insulating layer A and the case where the electrode B is formed on the right (or left) side of the insulating layer A.

The terms “adjacent” and “close” in this specification and the like do not necessarily mean that a component is directly in contact with another component. For example, the expression “electrode B adjacent to insulating layer A” does not necessarily mean that the electrode B is formed in direct contact with the insulating layer A and can mean the case where another component is provided between the insulating layer A and the electrode B.

In this specification and the like, the terms “film” and “layer” can be interchanged with each other depending on circumstances. For example, the term “conductive layer” can be changed into the term “conductive film” in some cases. As another example, the term “insulating film” can be changed into the term “insulating layer” in some cases. Moreover, such terms can be replaced with a word not including the term “film” or “layer” depending on the case or circumstances. For example, the term “conductive layer” or “conductive film” can be changed into the term “conductor” in some cases. Moreover, the term “conductor” can be changed into the term “conductive layer” or “conductive film” in some cases. As another example, the term “insulating layer” or “insulating film” can be changed into the term “insulator” in some cases. Moreover, the term “insulator” can be changed into the term “insulating layer” or “insulating film” in some cases.

In this specification and the like, the terms “electrode”, “wiring”, “terminal”, and the like do not limit the functions of components. For example, an “electrode” is used as part of a wiring in some cases, and vice versa. Moreover, the term “electrode” or “wiring” also includes the case where a plurality of “electrodes” or “wirings” are formed in an integrated manner, for example. As another example, a “terminal” is used as part of a “wiring” or an “electrode” in some cases, and vice versa. Furthermore, the term “terminal” includes the case where a plurality of electrodes, wirings, terminals, and the like are formed in an integrated manner. Therefore, for example, an “electrode” can be part of a wiring or a terminal, and a “terminal” can be part of a wiring or an electrode. Moreover, the terms “electrode”, “wiring”, and “terminal” are sometimes replaced with the term “region”, for example.

In this specification and the like, the terms “wiring”, “signal line”, “power supply line”, and the like can be interchanged with each other depending on the case or circumstances. For example, the term “wiring” can be changed into the term “signal line” in some cases. As another example, the term “wiring” can be changed into the term “power supply line” in some cases. Inversely, the term “signal line”, “power source line”, or the like can be changed into the term “wiring” in some cases. The term “power supply line” or the like can be changed into the term “signal line” or the like in some cases. Inversely, the term “signal line” or the like can be changed into the term “power source line” or the like in some cases. As another example, the term “signal” can be used instead of “potential” that is supplied to a wiring, depending on the case or circumstances. Inversely, the term “signal” or the like can be changed into the term “potential” in some cases.

In this specification, “parallel” indicates a state where the angle formed between two straight lines is greater than or equal to −10° and less than or equal to 10°. Thus, the case in which the angle is greater than or equal to −5° and less than or equal to 5° is also included. The terms “approximately parallel” and “substantially parallel” indicate that the angle formed between two straight lines is greater than or equal to −30° and less than or equal to 30°. The term “perpendicular” indicates that the angle formed between two straight lines is greater than or equal to 80° and less than or equal to 100°. Thus, the case in which the angle is greater than or equal to 85° and less than or equal to 95° is also included. The terms “approximately perpendicular” and “substantially perpendicular” indicate that the angle formed between two straight lines is greater than or equal to 60° and less than or equal to 120°.

In this specification and the like, the terms “identical”, “the same”, “equal”, “uniform”, and the like (including synonyms thereof) used in describing calculation values and actual measurement values allow for a margin of error of ±20%, unless otherwise specified.

Note that in the structures of the invention described in the embodiments, the same portions or portions having similar functions are denoted by the same reference numerals in different drawings and the description of such portions is not repeated in some cases. The same hatching pattern is used for portions having similar functions, and the portions are not denoted by specific reference numerals in some cases. Moreover, some components may be omitted in a perspective view, a top view, and the like for easy understanding of the diagrams.

In the drawings and the like related to this specification, the size, the layer thickness, or the region is exaggerated for clarity in some cases. Therefore, embodiments of the present invention are not limited to the size, aspect ratio, or the like shown in the drawings. Note that the drawings schematically show ideal examples, and the embodiment of the present invention is not limited to shapes or values shown in the drawings. For example, variation in signal, voltage, or current due to noise or difference in timing can be included.

In this specification and the like, when a plurality of components denoted by the same reference numerals need to be distinguished from each other, identification signs such as “A”, “b”, “_1”, “[n]”, and “[m,n]” are sometimes added to the reference numerals. For example, a plurality of subpixels 230 are sometimes shown individually as a subpixel 230R, a subpixel 230G, and a subpixel 230B.

### Embodiment 1

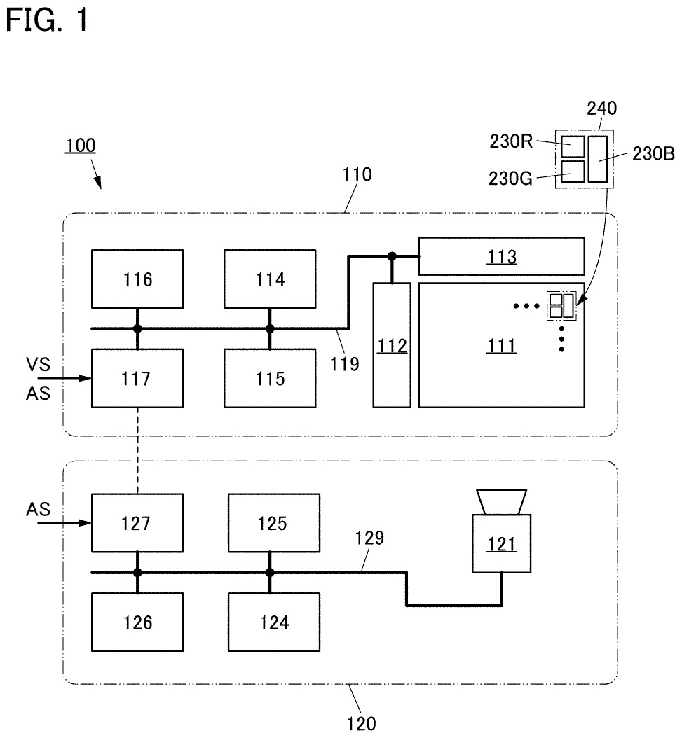

An image correction system according to one embodiment of the present invention will be described. FIG. 1 is a block diagram illustrating a configuration example of an image correction system 100.

### <Configuration Example of Image Correction System>

The image correction system 100 includes a display device 110 and a correction data generator 120.

### [Display Device]

The display device 110 includes a display portion 111, a gate driver circuit 112, a source driver circuit 113, a control device 114, an arithmetic device 115, a memory device 116, and an input/output device 117. The gate driver circuit 112, the source driver circuit 113, the control device 114, the arithmetic device 115, the memory device 116, and the input/output device 117 are electrically connected to each other through a bus line 119.

The display portion 111 includes a plurality of pixels 240 arranged in a matrix. The pixel 240 includes a subpixel 230R that emits red light, a subpixel 230G that emits green light, and a subpixel 230B that emits blue light. For example, the subpixel 230R includes a light-emitting element that emits red light, the subpixel 230G includes a light-emitting element that emits green light, and the subpixel 230B includes a light-emitting element that emits blue light.

The pixels 240 including the subpixels 230R, 230G, and 230B enable full-color display. A combination of emission colors of the subpixels included in the pixel 240 is not limited to red (R), green (G), and blue (B) and may be cyan (C), magenta (M), and yellow (Y). Moreover, the pixel 240 may include a subpixel that emits white light. The display portion 111 has a function of displaying an image by writing of video signals VS to the subpixels 230.

Note that “subpixels” refer to a plurality of pixels included in a pixel for achieving color display. Meanwhile, for single-color display such as monochrome display, it is not necessary to distinguish a subpixel from a pixel. Therefore, a “pixel” and a “subpixel” can be replaced with each other unless otherwise specified.

Using the pixels 240 arranged in a matrix of 1920×1080, the display device 110 can achieve full-color display with full high definition (also referred to as 2K resolution, 2K1K, 2K, and the like). As another example, using the pixels 240 arranged in a matrix of 3840×2160, the display device 110 can achieve full-color display with ultra-high definition (also referred to as 4K resolution, 4K2K, 4K, and the like). As another example, using the pixels 240 arranged in a matrix of 7680×4320, the display device 110 can achieve full-color display with super high definition (also referred to as 8K resolution, 8K4K, 8K, and the like). Using a larger number of pixels 240, the display device 110 can achieve full-color display with 16K or 32K resolution.

The control device 114 has a function of controlling the operation of the gate driver circuit 112, the source driver circuit 113, the arithmetic device 115, the memory device 116, and the input/output device 117 in accordance with a program retained in the memory device 116. For example, a central processing unit (CPU) may be used as the control device 114.

The memory device 116 has a function of storing a program, operation parameters, and the like related to the operation of the display device 110. As the memory device 116, it is possible to use a volatile memory device such as a dynamic random access memory (DRAM) or a static random access memory (SRAM). As the memory device 116, it is also possible to use a nonvolatile memory device such as an erasable programmable read only memory (EPROM), an electrically erasable programmable read-only memory (EEPROM), a flash memory, a magnetoresistive random access memory (MRAM), a phase change RAM (PRAM), a resistive RAM (ReRAM), or a ferroelectric RAM (FeRAM). Note that at least part of the memory device 116 is preferably a rewritable nonvolatile memory device.

As the memory device 116, a DOSRAM (registered trademark) using a transistor including an oxide semiconductor in a channel formation region (also referred to as an OS transistor) may be used. A DOSRAM can be composed of one transistor and one capacitor, so that a high-density memory can be achieved. The OS transistor exhibits an extremely low off-state current; thus, an data refresh interval can be lengthened.

As the memory device 116, a NOSRAM (registered trademark) may be used. A NOSRAM is composed of two transistors and one capacitor, and data is rewritten by charge and discharge of the capacitor; hence, the number of rewrites is not theoretically limited, and data writing and reading can be performed with low energy. A NOSRAM is capable of retaining multilevel data. When data retained (stored) in one memory cell is multilevel data with three levels or more, the storage capacity per memory cell can be larger than that in a DOSRAM.

A memory cell including an OS transistor can be referred to as an OS memory. A memory device including the memory cell can also be referred to as an OS memory. Since the OS transistor exhibits an extremely low off-state current, the OS memory can retain data for a long time even when power supply is stopped.

The video signal VS supplied from the outside, the operation parameters of the display device 110, and the like are stored in the memory device 116 via the input/output device 117. The display device 110 operates in accordance with the operation parameters. The input/output device 117 has a function of outputting a signal indicating an operation state of the display device 110, for example, to the outside.

Correction data supplied from the correction data generator 120 is stored in the memory device 116 via the input/output device 117. Note that the correction data will be described later.

The arithmetic device 115 has a function of performing a variety of signal processing on the video signal VS in accordance with, for example, the operation parameters of the display device 110. The arithmetic device 115 has a function of performing brightness (luminance) correction, contrast correction, color tone correction, and gamma correction on the video signal VS, for example. Note that a CPU, a graphics processing unit (GPU), or the like may be used as the arithmetic device 115.

In the arithmetic device 115, signal processing such as removal of a noise component of the video signal VS, edge enhancement, up-conversion, or down-conversion may be performed. When the video signal VS is up-converted or down-converted, a super-resolution circuit (not illustrated) may be provided in the display device 110.

The super-resolution circuit has a function of up-converting the video signal VS when the resolution of the video signal VS is lower than that of the display portion 111. The super-resolution circuit has a function of down-converting the video signal VS when the resolution of the video signal VS is higher than that of the display portion 111. The super-resolution circuit has a function of determining a video signal supplied to a given pixel included in the display portion 111 by product-sum operation of video signals supplied to pixels around the given pixel and a weight.

Providing the super-resolution circuit can reduce the load on the arithmetic device 115. For example, the arithmetic device 115 executes processing up to 2K resolution (or 4K resolution) and the super-resolution circuit performs up-conversion to 4K resolution (or 8K resolution), whereby the load on the arithmetic device 115 can be reduced. Down-conversion can be performed in a similar manner.

The arithmetic device 115 has a function of performing signal processing for correcting the video signal VS (also referred to as correction processing) for each pixel with the use of correction data stored in the memory device 116. By the correction processing, luminance variations and display unevenness in the display portion 111 are reduced. Thus, the display quality of the display device 110 is improved.

A variety of correction processing conducted in the arithmetic device 115 are preferably performed with digital signals. The arithmetic device 115 has a function of converting the video signal VS, which is a digital signal, into an analog signal after needed correction processing ends. The video signal VS converted into an analog signal is supplied to the display portion 111 through the source driver circuit 113. The gate driver circuit 112 and the source driver circuit 113 have a function of writing the video signal VS to the pixel 240 included in the display portion 111. Alternatively, the digital video signal VS may be supplied to the source driver circuit 113 and converted into an analog signal in the source driver circuit 113. In such a manner, an image can be displayed on the display portion 111.

### [Correction Data Generator]

The correction data generator 120 includes an imaging device 121, a control device 124, an arithmetic device 125, a memory device 126, and an input/output device 127. The imaging device 121, the control device 124, the arithmetic device 125, the memory device 126, and the input/output device 127 are electrically connected to each other through a bus line 129.

The control device 124 has a function of controlling the operation of the imaging device 121, the arithmetic device 125, the memory device 126, and the input/output device 127 in accordance with a program stored in the memory device 126. As in the case of the control device 114, a CPU may be used as the control device 124. A CPU or a GPU may be used as the arithmetic device 125.

The imaging device 121 has a function of capturing an image displayed on the display portion 111 and obtaining imaging data. Thus, the imaging data includes two-dimensional luminance distribution. In other words, the imaging device 121 has a function of obtaining luminance distribution of an image displayed on the display portion 111 as two-dimensional information.

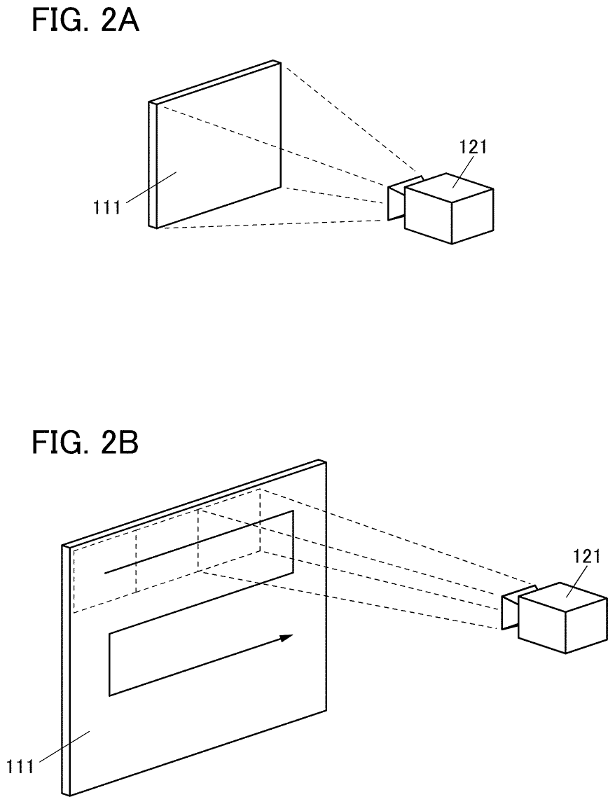

FIG. 2A is a schematic perspective view of the display portion 111 and the imaging device 121. An image displayed on the display portion 111 is captured with the imaging device 121, whereby luminance distribution of the display portion 111 is obtained. As the imaging device 121, an image sensor, a luminance meter, or the like can be used.

The definition of the imaging device 121 is preferably higher than the definition of the display portion 111. The definition of the imaging device 121 is preferably four times or more, further preferably nine times or more the definition of the display portion 111. When the area of the display portion 111 is larger than the shooting range of the imaging device 121 as illustrated in FIG. 2B, when the definition of the imaging device 121 is lower than the definition of the display portion 111, or when an image of the display portion 111 is intended to be captured with higher accuracy, the shooting range of the imaging device 121 is set smaller than the area of the display portion 111 and image capturing is performed while the display portion 111 is scanned.

In the case where the imaging device 121 performs image capturing while scanning the display portion 111, one or both of the display portion 111 and the imaging device 121 can be moved.

The arithmetic device 125 has a function of obtaining luminance data of each pixel by using the obtained luminance distribution. The arithmetic device 125 calculates correction data for each pixel by comparing the obtained luminance data of each pixel with a video signal. At this time, an image displayed on the display portion 111 preferably has a single color. To obtain accurate luminance distribution, it is preferable to supply the same luminance data to all the pixels. A CPU or a GPU may be used as the arithmetic device 125.

For example, the video signal VS to express a single-color image with the same luminance data (gray level) in all the pixels is supplied as a correction video signal AS to the display device 110 and the correction data generator 120. The correction video signal AS may be supplied to the correction data generator 120 through the display device 110. Alternatively, the correction video signal AS may be supplied to the display device 110 through the correction data generator 120.

An image displayed on the display portion 111 using the correction video signal AS is captured by the imaging device 121, and luminance data of each pixel is obtained. By comparing the obtained luminance data of each pixel with the correction video signal AS, correction data for each pixel can be calculated.

The memory device 126 has a function of storing a program, operation parameters, and the like related to the operation of the correction data generator 120. The memory device 126 also has a function of storing imaging data obtained by the imaging device 121, the arithmetic results of the arithmetic device 125, and correction data for each pixel. As the memory device 126, a memory device similar to the memory device 116 can be used.

The correction video signal AS supplied from the outside, the operation parameters of the correction data generator 120, and the like are stored in the memory device 126 via the input/output device 127. The correction data generator 120 operates in accordance with the operation parameters. The input/output device 127 has a function of outputting a signal indicating an operation state of the correction data generator 120, for example, to the outside.

Correction data for each pixel, which is generated in the correction data generator 120, is supplied to the input/output device 117 of the display device 110 through the input/output device 127, and stored in the memory device 116.

Note that the configuration of the image correction system 100 according to one embodiment of the present invention is not limited to the configuration described in this embodiment. The image correction system 100 according to one embodiment of the present invention may omit some of the components described in this embodiment, and/or may include a component that is not described in this embodiment.

The CPU used in the image correction system 100 according to one embodiment of the present invention may be a normally-off CPU (also referred to as NoffCPU (registered trademark)). In the NoffCPU, power supply to a circuit that does not need to operate can be stopped so that the circuit can be brought into a standby state. The circuit brought into the standby state because of the stop of power supply does not consume power. Thus, the power usage of the NoffCPU can be minimized.

As memory devices such as a cache and a register included in the NoffCPU, OS memories are preferably used. An OS memory can retain data for a long time even when power supply is stopped. When information such as operation parameters is held (stored) in the OS memory, a circuit in a standby state in the NoffCPU can be restored only by restarting power supply to the circuit, meaning that rewriting the operation parameters or the like is unnecessary. In other words, high-speed return from the standby state is possible. As described here, power consumption of the NoffCPU can be reduced without a significant decrease in operating speed.

The GPU used in the image correction system 100 according to one embodiment of the present invention may be a normally-off GPU (also referred to as NoffGPU (registered trademark)). In the NoffGPU as well as in the NoffCPU, power supply to a circuit that does not need to operate can be stopped so that the circuit can be brought into a standby state.

When OS memories are used as memory devices such as a cache and a register included in the NoffGPU as in the NoffCPU, high-speed return from the standby state is possible. Thus, power consumption of the NoffGPU can be reduced without a significant decrease in operating speed.

### <Operation Example of Image Correction System)

Next, the operation of the image correction system 100 will be described.

### [Generation of Correction Data]

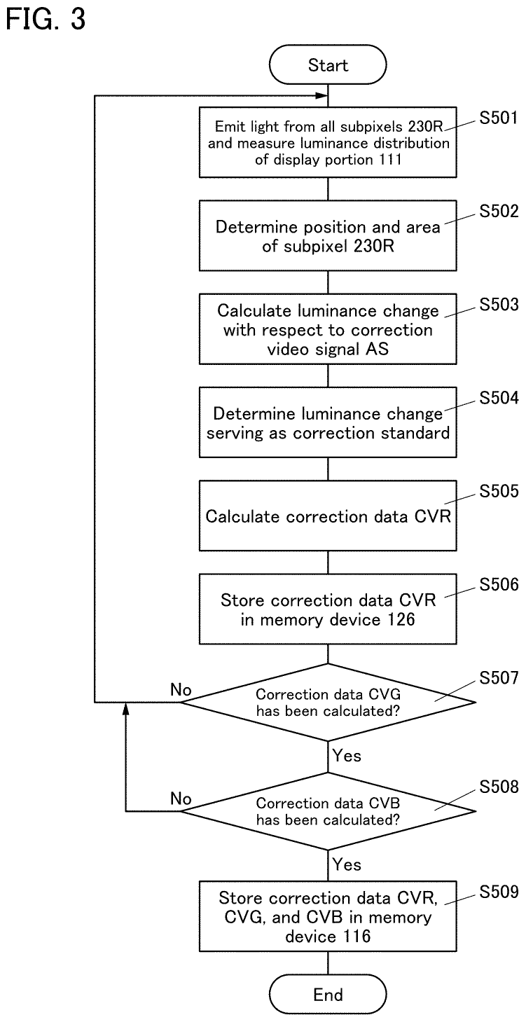

First, an operation example of the correction data generator 120 is described. In this embodiment, an example of generating correction data by the correction data generator 120 is described. Here, a method for obtaining correction data for the subpixel 230R in the display portion 111 is mainly described. FIG. 3 is a flow chart showing the operation of the correction data generator 120.

### [Step S501]

The correction video signal AS is supplied to all the subpixels 230R included in the display portion 111 so that all the subpixels 230R emit light, and luminance distribution of the display portion 111 is captured by the imaging device 121. The obtained imaging data is stored in the memory device 126. At that time, image capturing is performed while the correction video signal AS is changed from a first correction video signal AS1 to a second correction video signal AS2.

The correction video signal AS is a signal indicating a gray level. Accordingly, the first correction video signal AS1 may be referred to as first gray level. The second correction video signal AS2 may be referred to as second gray level. For example, the first correction video signal AS1 indicates a gray level for which the subpixel 230R emits light with low luminance, and the second correction video signal AS2 indicates a gray level for which the subpixel 230R emits light with high luminance. Note that the first correction video signal AS1 does not necessarily correspond to the minimum gray level (lowest luminance), and the second correction video signal AS2 does not necessarily correspond to the maximum gray level (highest luminance).

### [Step S502]

Next, with the use of the imaging data obtained in Step S501, the positions and the areas S of all the subpixels 230R in the imaging data are determined. The positions can be determined using luminance distribution in the imaging data based on a given correction video signal AS. The positions and the areas S of all the subpixels 230R can be determined from the periodicity of a plurality of luminance peaks that appear repeatedly in the luminance distribution.

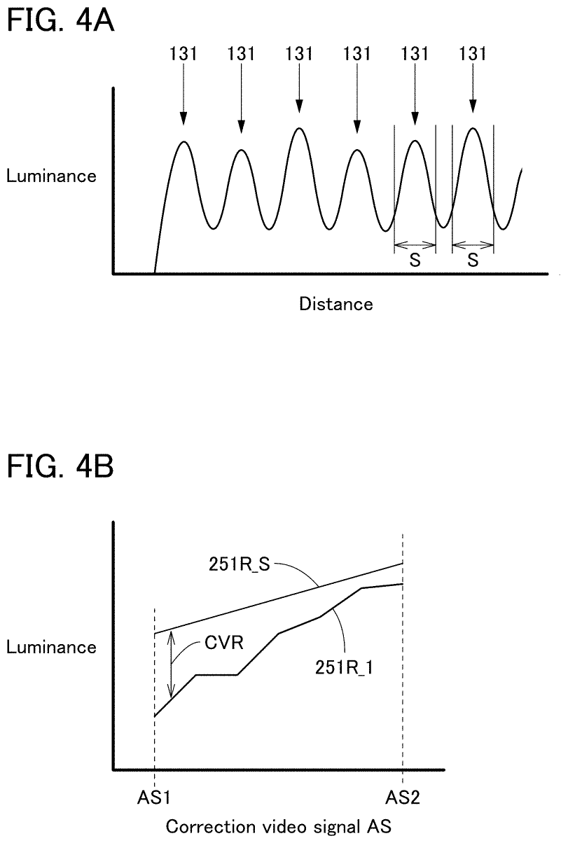

As an example, FIG. 4A illustrates luminance distribution obtaining by extracting part of imaging data in a given direction. In FIG. 4A, the horizontal axis represents distance, and the vertical axis represents luminance. FIG. 4A illustrates one-dimensional luminance distribution; the positions and the areas S of all the subpixels 230R in the imaging data can be determined by examining the positions and appearance cycles of peaks 131 that appear repeatedly in the imaging data.

Note that the position and the area S of each subpixel 230R in imaging data do not have to be precise. The positions of the subpixels 230R are determined so that the arrangement of the subpixels 230R included in the display portion 111 can be substantially specified. Note that all the subpixels 230R can have the same area S as long as a region occupied by one subpixel 230R does not interfere with the adjacent subpixel 230R. For example, a given value may be used as the area S. For example, when the arrangement and areas of all the subpixels 230R in the display portion 111 are known, these values are used as the positions and the areas S of the subpixels 230R in imaging data.

Note that luminance distribution in imaging data is distorted or inclined in some cases depending on the performance of an optical component and the like included in the imaging device 121 and imaging conditions. For easy determination of the position and the area S of the subpixel 230R, distortion or inclination of luminance distribution in imaging data is preferably as small as possible. When distortion or inclination of luminance distribution in imaging data is large, arithmetic processing for adjusting it may be performed.

The position and the area S of the subpixel 230R may be determined by image processing using artificial intelligence (AI) technology or the like.

### [Step S503]

Since light emitted from the subpixel 230R is not necessarily uniform in the area S, the integral of luminance in the area S is calculated using the obtained luminance distribution. Since luminance is a luminous intensity per unit area, the integral indicates a luminous intensity per subpixel 230R. In other words, a value obtained by dividing the luminous intensity of one subpixel 230R by the area S is luminance. Accordingly, when all the subpixels 230 included in the display portion 111 have the same area S, “luminance” and “luminous intensity” can be replaced with each other in some cases.

For all the subpixels 230R, a luminance change (luminous intensity change) of the subpixel 230R with respect to the correction video signal AS at the time when the correction video signal AS is changed from the first correction video signal AS1 to the second correction video signal AS2 is calculated.

As an example, FIG. 4B illustrates the results of calculating a luminance change (also referred to as a luminance profile) of one subpixel 230R with respect to the correction video signal AS, as a luminance profile 251R_1. In FIG. 4B, the horizontal axis represents the correction image signal AS, and the vertical axis represents luminance. As described above, the correction video signal AS is also a signal indicating a gray level. Accordingly, the horizontal axis in FIG. 4B may be regarded as a gray level or grayscale.

In this embodiment and the like, all the subpixels 230 have the same area S; hence, the vertical axis in FIGS. 4A and 4B may be regarded as luminous intensity. Therefore, “luminance profile” may be replaced with “luminous intensity profile”.

In the case where the correction video signal AS is a voltage, the horizontal axis in FIG. 4B may be regarded as voltage. Thus, the first correction video signal AS1 and the second correction video signal AS2 can be referred to as a first voltage and a second voltage, respectively.

### [Step S504]

Next, a luminance change (luminous intensity change) to be a correction target is determined. In this embodiment and the like, a luminance change (luminous intensity change) to be a correction target is also referred to as a correction standard or a correction standard profile.

For example, a luminance profile of the subpixel 230R with the highest luminance at the time when the correction video signal AS is the first correction video signal AS1 may be used as a correction standard profile. A luminance profile of the subpixel 230R with an average luminance or a luminance close to the average luminance at the time when the correction video signal AS is the first correction video signal AS1 may be used as a correction standard profile. A luminance profile of the subpixel 230R with a median luminance or a luminance close to the median luminance at the time when the correction video signal AS is the first correction video signal AS1 may be used as a correction standard profile. Furthermore, without using the luminance profile of the subpixel 230R, a correction standard profile may be set separately. As an example, FIG. 4B illustrates a correction standard profile 251R_S.

### [Step S505]

Subsequently, in order to correct a luminance profile of a first subpixel 230R (also referred to as the luminance profile 251R_1) to match the correction standard profile 251R_S, first correction data CVR (also referred to as correction data CVR_1) is calculated. Specifically, correction data CVR that is a difference between the correction standard profile 251R_S and the luminance profile 251R_1 is calculated.

The correction data CVR for each of the subpixels 230R is calculated. The correction data CVR is preferably calculated for all gray levels from the first correction video signal AS1 (first gray level) to the second correction video signal AS2 (second gray level). Note that the correction data CVR may be calculated for every given gray levels, instead of being calculated for each gray level. For example, when the correction standard profile 251R_S and the luminance profile 251R_1 are each regarded as a straight line and have the same or substantially the same inclination, a value calculated at the first gray level is used as the correction data CVR_1 for all gray levels.

The average value of the correction data CVR for a plurality of adjacent subpixels 230R may be used as common correction data CVR among the adjacent subpixels 230R. In that case, storage capacity needed for holding the correction data CVR is reduced, and the load on the memory device 116 and the memory device 126 can be reduced. Thus, power consumption of the display device 110 and the correction data generator 120 can be reduced.

Furthermore, a histogram may be produced using the luminance distribution obtained in Step S501, and the correction data CVR may be calculated only for subpixels 230R that are not within the standard range. In that case, storage capacity needed for holding the correction data CVR is reduced, and the load on the memory device 116 and the memory device 126 can be reduced. Hence, power consumption of the display device 110 and the correction data generator 120 can be reduced.

### [Step S506]

Then, the calculated correction data CVR is stored in the memory device 126.

### [Step S507]

In the case where correction data CVG that is a correction value for the subpixel 230G is not calculated, Step S501 to Step S506 are performed, with the subpixel 230R and the correction data CVR in Step S501 to Step S506 replaced with the subpixel 230G and the correction data CVG.

### [Step S508]

In the case where correction data CVB that is a correction value for the subpixel 230B is not calculated, Step S501 to Step S506 are performed, with the subpixel 230R and the correction data CVR in Step S501 to Step S506 replaced with the subpixel 230B and the correction data CVB.

### [Step S509]

The correction data CVR, the correction data CVG, and the correction data CVB stored in the memory device 126 are supplied to the display device 110 and stored in the memory device 116. Note that in this specification and the like, the correction data CVR, the correction data CVG, and the correction data CVB are collectively referred to as correction data CV in some cases.

The correction data CVR, the correction data CVG, and the correction data CVB for each subpixel can be generated by the configuration and the method described as an example in this embodiment.

In the case where the imaging device 121 can obtain luminance distributions of red light, green light, and blue light separately, Step S501 may be performed while the subpixel 230R, the subpixel 230G, and the subpixel 230B in the pixel 240 are made to emit light at the same time.

When luminance distributions of the subpixels 230 (the subpixel 230R, the subpixel 230G, and the subpixel 230B) are obtained at the same time, calculation of the correction data CV (the correction data CVR, the correction data CVG, and the correction data CVB) in Step S502 to Step S506 can be performed in parallel. Thus, Step S507 and Step S508 can be omitted. When the luminance distributions of the subpixels 230 are concurrently obtained, the time for calculating the correction data CV can be shortened.

In the image correction system according to one embodiment of the present invention, luminance variations and display unevenness in the display portion 111 are reduced, and the display quality of the display device 110 is improved.

Note that the method for generating correction data according to one embodiment of the present invention is not limited to that described in this embodiment. The method for generating correction data according to one embodiment of the present invention may omit some of the components described in this embodiment, and/or may include a component that is not described in this embodiment.

### [Correction of Video Signal]

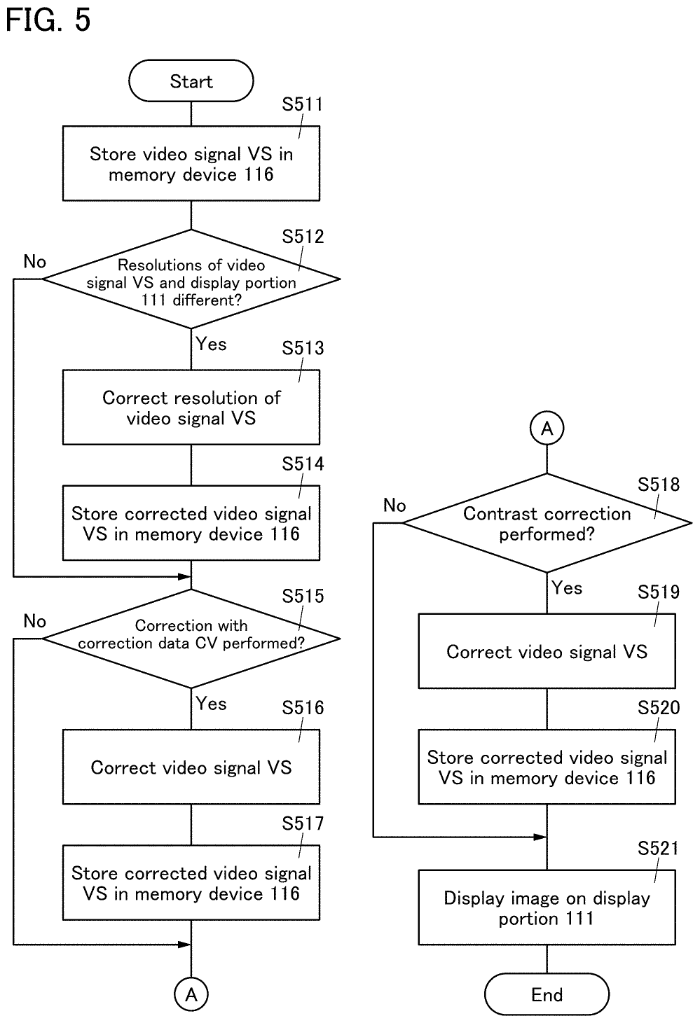

Next, an operation example of the display device 110 is described. In this embodiment, an example of correcting a video signal in the display device 110 is described. FIG. 5 is a flow chart showing the operation of the display device 110.

### [Step S511]

The video signal VS supplied to the display device 110 through the input/output device 117 is stored in the memory device 116.

### [Step S512]

Whether the resolution of the video signal VS is different from that of the display portion 111 is judged. Step S513 is performed when they have different resolutions. Step S515 is performed when they have the same resolution.

### [Step S513]

The arithmetic device 115 performs correction for matching the resolution of the video signal VS to that of the display portion 111. The correction for matching the resolutions may be up-conversion or down-conversion. In the case where the resolution of the video signal VS is higher than that of the display portion 111, data on a region that cannot be displayed on the display portion 111 may be removed from the video signal VS. In the case where the resolution of the video signal VS is lower than that of the display portion 111, given data may be added to the video signal VS.

### [Step S514]

The corrected video signal VS is stored in the memory device 116.

### [Step S515]

Then, whether the video signal VS is corrected using the correction data CV is determined on the basis of operation parameters stored in the memory device 116. Step S516 is conducted when correction of the video signal VS using the correction data CV is performed. Step S518 is conducted when the video signal VS is not corrected.

### [Step S516]

In the arithmetic device 115, the video signal VS for each pixel is corrected using the correction data CV stored in the memory device 116. Specifically, the gray level of each of the subpixels 230R included in the video signal VS is corrected using the correction data CVR corresponding to each of the subpixels 230R. Similarly, the gray level of each of the subpixels 230G included in the video signal VS is corrected using the correction data CVG corresponding to each of the subpixels 230G. Similarly, the gray level of each of the subpixels 230B included in the video signal VS is corrected using the correction data CVB corresponding to each of the subpixels 230B.

### [Step S517]

The video signal VS that has been corrected using the correction data CV is stored in the memory device 116.

### [Step S518]

Next, whether brightness correction, contrast correction, color tone correction, gamma correction, removal of a noise component of the video signal VS, edge enhancement, or the like is performed on the corrected video signal VS is determined on the basis of the operation parameters stored in the memory device 116.

For example, in Step S518, whether contrast correction is performed on the corrected video signal VS is determined on the basis of the operation parameters stored in the memory device 116. Step S519 is conducted when contrast correction is performed. Step S521 is conducted when contrast correction is not performed.

### [Step S519]

In the arithmetic device 115, contrast correction is performed on the video signal VS.

### [Step S520]

The video signal VS corrected in Step S519 is stored in the memory device 116.

Although Step S518 to Step S520 are described using the contrast correction as an example in this embodiment, another correction can be performed in a similar manner.

### [Step S521]

With the video signal VS that has been subjected to needed correction processing, an image is displayed on the display portion 111. In the above manner, needed correction processing can be performed on the video signal VS, and an image can be displayed on the display portion 111 by using the corrected video signal VS. Performing correction processing enables high-quality images to be displayed. Thus, the display device 110 with high display quality can be achieved.

Note that the method for correcting the video signal VS according to one embodiment of the present invention is not limited to that described in this embodiment. The method for correcting the video signal according to one embodiment of the present invention may omit some of the components described in this embodiment, and/or may include a component that is not described in this embodiment.

At least part of this embodiment can be implemented in combination with any of the other embodiments described in this specification as appropriate.

### Embodiment 2

This embodiment will describe adjustment of the correction data CV (the correction data CVR, the correction data CVG, and the correction data CVB) considering the color temperature at the time of white display.

The display portion 111 displays an image based on the video signals VS that have been corrected using the correction data CV. When the video signals VS are signals for displaying white, white display with an intended color temperature cannot be obtained in some cases. This is because a variation in color temperature occurs owing to the difference in luminance of the subpixel 230R, the subpixel 230G, and the subpixel 230B. One of the reasons is that individual calculation of the correction data CVR, the correction data CVG, and the correction data CVB causes a variation in color temperature of the video signals VS corrected using the correction data CV.

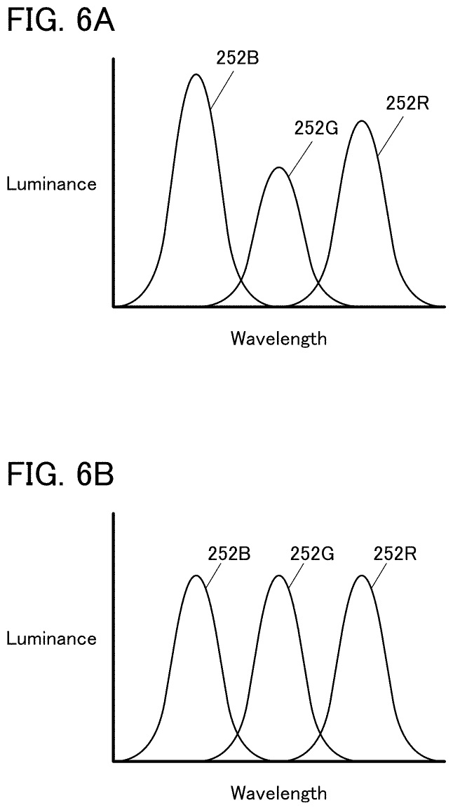

As an example, FIG. 6A illustrates a luminance profile (luminance 252R) of the subpixel 230R corrected with the correction data CVR, a luminance profile (luminance 252G) of the subpixel 230G corrected with the correction data CVG, and a luminance profile (luminance 252B) of the subpixel 230B corrected with the correction data CVB.

Here, given that the case where the three luminance profiles have the same peak luminance (highest luminance) corresponds to white display with an intended color temperature, FIG. 6A illustrates that white display with an intended color temperature is not obtained.

Adjusting luminance of red light, green light, and blue light to obtain white light with an intended color temperature (i.e., “white balance”) is also referred to as adjusting white balance or adjusting color balance. White balance can be adjusted by the arithmetic device 115. Note that in the case where the color temperatures of the video signals VS corrected using the correction data CV are significantly unbalanced, the arithmetic device 115 cannot sufficiently adjust the color temperature in some cases.

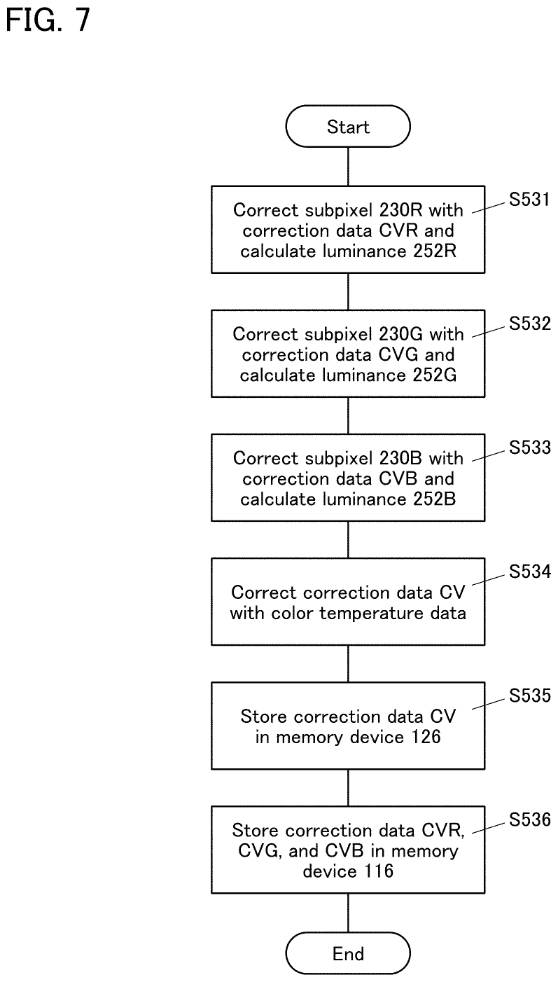

For this reason, it is preferred that in addition to the above embodiment, the correction data generator 120 modify the correction data CV in consideration of white balance. This embodiment will describe modification of the correction data CVR, CVG, and CVB considering white balance. FIG. 7 is a flow chart showing a method for modifying correction data in consideration of white balance.

The white balance is adjusted using the imaging data (luminance distribution) stored in the memory device 126 in Step S501 and the correction data CVR, CVG, and CVB.

### [Step S531]

First, the luminance of the subpixel 230R obtained in Step S501 is corrected with the correction data CVR, and the luminance 252R is calculated. The luminance 252R is calculated for all the subpixels 230R. Note that the luminance 252R may be calculated using the average luminance of some or all of the subpixels 230R.

### [Step S532]

Next, the luminance of the subpixel 230G obtained in Step S501 is corrected with the correction data CVG, and the luminance 252G is calculated. The luminance 252G is calculated for all the subpixels 230G. Note that the luminance 252G may be calculated using the average luminance of some or all of the subpixels 230G.

### [Step S533]

Then, the luminance of the subpixel 230B obtained in Step S501 is corrected with the correction data CVB, and the luminance 252B is calculated. The luminance 252B is calculated for all the subpixels 230B. Note that the luminance 252B may be calculated using the average luminance of some or all of the subpixels 230B.

### [Step S534]

The memory device 126 includes color temperature data for achieving white light with a particular color temperature. The arithmetic device 125 compares the color temperature data with the luminance 252R, the luminance 252G, and the luminance 252B and corrects the values of the correction data CVR, CVG, and CVB as needed.

The color temperature is often adjusted in the range of 2000 Kelvin (K) to 8000 K. Thus, the color temperature data stored in the memory device 126 is any data for reproducing white light with a color temperature higher than or equal to 4000 K and lower than or equal to 6000 K.

### [Step S535]

The correction data CVR, the correction data CVG, and the correction data CVB that have been corrected using the color temperature data are stored in the memory device 126.

### [Step S536]

The correction data CVR, the correction data CVG, and the correction data CVB held in the memory device 126 are supplied to the display device 110 and stored in the memory device 116.

The white balance can be adjusted in the above manner. FIG. 6B illustrates an example of the luminance 252R, the luminance 252G, and the luminance 252B after the white balance adjustment.

The correction data CVR, CVG, and CVB are modified in consideration of white balance, whereby images with more natural color tones can be displayed. Thus, the display quality of the display device can be further improved. FIG. 6B illustrates the results of adjusting the correction data CVR, CVG, and CVB so that the maximum values of the luminance 252R, the luminance 252G, and the luminance 252B are equal to each other; however, one embodiment of the present invention is not limited thereto. The values of the luminance 252R, the luminance 252G, and the luminance 252B differ depending on the color temperature to be set.

Modification of the correction data CVR, CVG, and CVB for adjusting color balance may be performed for all gray levels from the first correction video signal AS1 to the second correction video signal AS2; alternatively, a modification value obtained with the correction video signal AS for a given gray level may be used as a correction value for all gray levels from the first correction video signal AS1 to the second correction video signal AS2.

Note that the method for adjusting white valance according to one embodiment of the present invention is not limited to that described in this embodiment. The method for adjusting white valance according to one embodiment of the present invention may omit some of the components described in this embodiment, and/or may include a component that is not described in this embodiment.

At least part of this embodiment can be implemented in combination with any of the other embodiments described in this specification as appropriate.

### Embodiment 3

In this embodiment, a structure example of a display device 200 that can be used in the display device 110 will be described.

The display device described in this embodiment is a display device including a light-emitting element (also referred to as a light-emitting device). The display device includes at least two types of light-emitting elements that emit light of different colors. The light-emitting elements each include a pair of electrodes and an EL layer therebetween. The light-emitting element is preferably an organic electroluminescent element (organic EL element). Two or more light-emitting elements that exhibit different colors include respective EL layers containing different light-emitting materials. For example, three kinds of light-emitting elements that emit red (R), green (G), and blue (B) light are included, whereby a full-color display device can be obtained.

In the case of manufacturing a display device including a plurality of light-emitting elements that emit light of different colors, at least layers (light-emitting layers) containing light-emitting materials different in emission color each need to be formed in an island shape. In a known method for separately forming part or the whole of an EL layer, an island-shaped organic film is formed by an evaporation method using a shadow mask such as a metal mask. However, this method causes a deviation from the designed shape and position of an island-shaped organic film due to various influences such as low accuracy of the metal mask position, a positional deviation between the metal mask and a substrate, a warp of the metal mask, and vapor-scattering-induced expansion of the outline of the deposited film; accordingly, it is difficult to achieve high resolution and a high aperture ratio. In addition, the outline of the layer may blur during vapor deposition, whereby the thickness of an end portion may be small. That is, the thickness of the island-shaped light-emitting layer may vary from area to area. In the case of manufacturing a display device with a large size, high definition, or high resolution, the manufacturing yield might be reduced because of low dimensional accuracy of the metal mask and deformation due to heat or the like. Thus, a measure has been taken for pseudo improvement in resolution (also referred to pixel density). As a specific measure, a unique pixel arrangement such as a PenTile pattern has been employed.

Note that in this specification and the like, the term “island shape” refers to a state where two or more layers formed using the same material in the same step are physically separated from each other. For example, “island-shaped light-emitting layer” means a state where the light-emitting layer and its adjacent light-emitting layer are physically separated from each other.

In one embodiment of the present invention, fine patterning of an EL layer is performed by photolithography without a shadow mask such as a fine metal mask (FMM). With the patterning, a high-resolution display device with a high aperture ratio, which has been difficult to achieve, can be fabricated. Moreover, EL layers can be formed separately, enabling the display device to perform extremely clear display with high contrast and high display quality. Note that fine patterning of an EL layer may be performed using both a metal mask and photolithography, for example.

Part or the whole of the EL layer can be physically partitioned, inhibiting a leakage current flowing between adjacent light-emitting elements through a layer (also referred to as a common layer) shared by the light-emitting elements. This can prevent crosstalk due to unintended light emission, so that a display device with extremely high contrast can be obtained. Specifically, a display device having high current efficiency at low luminance can be obtained.

Note that a display device of one embodiment of the present invention can also be obtained by combining white-light-emitting elements with a color filter. In that case, the light-emitting elements having the same structure can be provided in pixels (subpixels) that emit light of different colors, allowing all the layers to be common layers. Furthermore, part or the whole of the EL layer is partitioned by photolithography, which inhibits a leakage current from flowing through the common layers to achieve a display device with high contrast. In particular, when an element has a tandem structure in which a plurality of light-emitting layers are stacked with a highly conductive intermediate layer therebetween, a leakage current through the intermediate layer can be effectively prevented, achieving a display device with high luminance, high resolution, and high contrast.

Furthermore, an insulating layer that covers at least a side surface of the island-shaped light-emitting layer is preferably provided. The insulating layer may cover part of a top surface of the island-shaped EL layer. For the insulating layer, a material having a barrier property against water and oxygen is preferably used. For example, an inorganic insulating film that is less likely to diffuse water or oxygen can be used. Thus, deterioration of the EL layer is inhibited, and a highly reliable display device can be achieved.

Between two light-emitting elements that are adjacent to each other, there is a region (depression) where the EL layers of the light-emitting elements are not provided. In the case where the depression is covered with a common electrode or with a common electrode and a common layer, the common electrode might be partitioned (or disconnected) by a step at an end portion of the EL layer, thereby causing insulation of the common electrode over the EL layer. In view of this, the local gap between the two adjacent light-emitting elements is preferably filled with a resin layer serving as a planarization film (such a structure is also referred to as local filling planarization, or LFP). The resin layer has a function of a planarization film. This structure can inhibit a step-cut of the common layer or the common electrode, making it possible to obtain a highly reliable display device.

A more specific structure example of the display device 200 will be described below with reference to drawings.

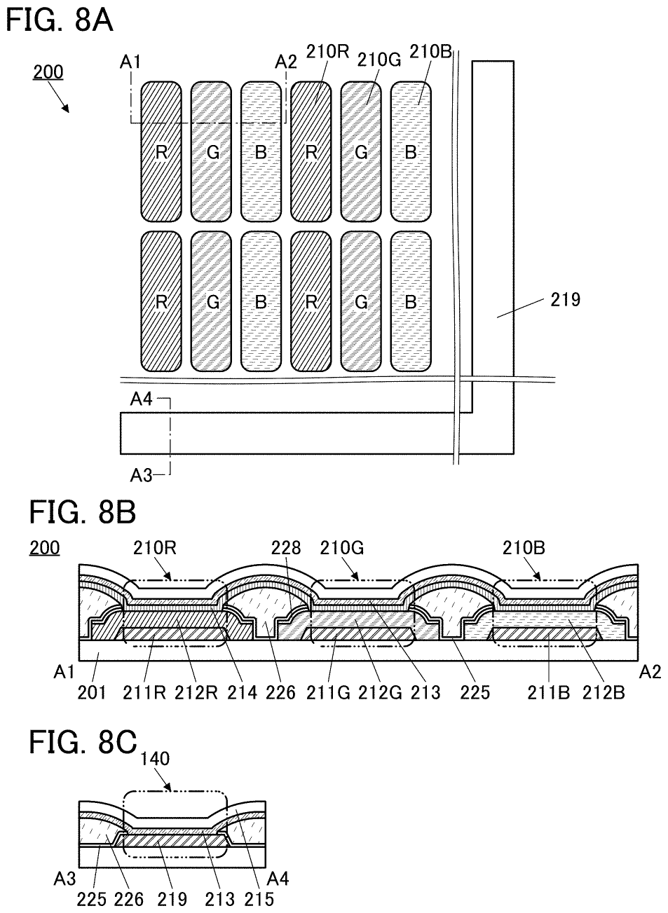

FIG. 8A is a schematic top view of the display device 200. The display device 200 includes, over a substrate 201, a plurality of light-emitting elements 210R that exhibit red, a plurality of light-emitting elements 210G that exhibit green, and a plurality of light-emitting elements 210B that exhibit blue. The light-emitting element 210 corresponds to the light-emitting element included in the subpixel 230 described in the above embodiment. In FIG. 8A, light-emitting regions of the light-emitting elements are denoted by R, G, and B to easily differentiate the light-emitting elements.

The light-emitting elements 210R, the light-emitting elements 210G, and the light-emitting elements 210B are arranged in a matrix. FIG. 8A shows what is called a stripe arrangement, in which the light-emitting elements of the same color are arranged in one direction. Note that the arrangement of the light-emitting elements is not limited thereto; another arrangement such as an S stripe, delta, Bayer, zigzag, PenTile, or diamond pattern may also be used.

As each of the light-emitting elements 210R, 210G, and 210B, an organic light-emitting diode (OLED) or a quantum-dot light-emitting diode (QLED) is preferably used, for example. Examples of a light-emitting substance included in the EL elements include a substance that exhibits fluorescence (a fluorescent material), a substance that exhibits phosphorescence (a phosphorescent material), an inorganic compound (e.g., a quantum dot material), and a substance that exhibits thermally activated delayed fluorescence (a thermally activated delayed fluorescent (TADF) material).

FIG. 8A also illustrates a connection electrode 219 that is electrically connected to a common electrode 213. The connection electrode 219 is supplied with a potential (e.g., an anode potential or a cathode potential) that is to be supplied to the common electrode 213. The connection electrode 219 is provided outside a display region where the light-emitting elements 210R and the like are arranged.

The connection electrode 219 can be provided along the outer periphery of the display region. For example, the connection electrode 219 may be provided along one side of the outer periphery of the display region or along two or more sides of the outer periphery of the display region. That is, in the case where the display region has a rectangular top surface, the top surface of the connection electrode 219 can have a band shape (a rectangular shape), an L shape, a square bracket shape, a quadrangular shape, or the like.

FIGS. 8B and 8C are schematic cross-sectional views along the dashed-dotted line A1-A2 and the dashed-dotted line A3-A4 in FIG. 8A. FIG. 8B is a schematic cross-sectional view of the light-emitting element 210R, the light-emitting element 210G, and the light-emitting element 210B. FIG. 8C is a schematic cross-sectional view of a connection portion 140 where the connection electrode 219 and the common electrode 213 are connected to each other.

The light-emitting element 210R includes a pixel electrode 211R, an organic layer 212R, a common layer 214, and the common electrode 213. The light-emitting element 210G includes a pixel electrode 211G, an organic layer 212G, the common layer 214, and the common electrode 213. The light-emitting element 210B includes a pixel electrode 211B, an organic layer 212B, the common layer 214, and the common electrode 213. The common layer 214 and the common electrode 213 are shared by the light-emitting element 210R, the light-emitting element 210G, and the light-emitting element 210B.

The organic layer 212R included in the light-emitting element 210R contains a light-emitting organic compound that emits light with intensity at least in a red wavelength range. The organic layer 212G included in the light-emitting element 210G contains a light-emitting organic compound that emits light with intensity at least in a green wavelength range. The organic layer 212B included in the light-emitting element 210B contains a light-emitting organic compound that emits light with intensity at least in a blue wavelength range. Each of the organic layers 212R, 212G, and 212B can also be referred to as an EL layer and includes at least a layer containing a light-emitting organic compound (a light-emitting layer).

Hereafter, the term “light-emitting element 210” is sometimes used to describe matters common to the light-emitting elements 210R, 210G, and 210B. Likewise, in the description of matters common to the components that are distinguished using alphabets, such as the organic layers 212R, 212G, and 212B, reference numerals without such alphabets are sometimes used.

The organic layer 212 and the common layer 214 can each independently include one or more of an electron-injection layer, an electron-transport layer, a hole-injection layer, and a hole-transport layer. For example, the organic layer 212 can include a hole-injection layer, a hole-transport layer, a light-emitting layer, and an electron-transport layer that are stacked from the pixel electrode 211 side, and the common layer 214 can include an electron-injection layer.

The pixel electrode 211R, the pixel electrode 211G, and the pixel electrode 211B are provided for the respective light-emitting elements. Each of the common electrode 213 and common layer 214 is provided as a continuous layer shared by the light-emitting elements. A conductive film that has a property of transmitting visible light is used for either the respective pixel electrodes or the common electrode 213, and a reflective conductive film is used for the other. When the respective pixel electrodes are light-transmitting electrodes and the common electrode 213 is a reflective electrode, a bottom-emission display device is obtained. Meanwhile, when the respective pixel electrodes are reflective electrodes and the common electrode 213 is a light-transmitting electrode, a top-emission display device is obtained. Note that when both the respective pixel electrodes and the common electrode 213 transmit light, a dual-emission display device is obtained.

A protective layer 215 is provided over the common electrode 213 so as to cover the light-emitting elements 210R, 210G, and 210B. The protective layer 215 has a function of preventing diffusion of impurities such as water into the light-emitting elements from above.

The pixel electrode 211 preferably has an end portion with a tapered shape. In the case where the pixel electrode has an end portion with a tapered shape, the organic layer 212 that is provided along a side surface of the pixel electrode also has a tapered shape. When the side surface of the pixel electrode is tapered, coverage with an EL layer provided along the side surface of the pixel electrode can be improved. The side surface of the pixel electrode having a tapered shape is preferred because it allows a foreign matter (such as dust or particles) mixing during the manufacturing process to be easily removed by treatment such as cleaning.

In this specification and the like, a tapered shape indicates a shape in which at least part of a side surface of a component is inclined with respect to a bottom surface of the component. For example, a tapered shape preferably includes a region where the angle between the inclined side surface and the bottom surface (such an angle is also referred to as a taper angle) is less than 90°.

The organic layer 212 has an island shape as a result of processing by photolithography. Thus, the angle formed between a top surface and a side surface of an end portion of the organic layer 212 is close to 90°. By contrast, an organic film formed using a fine metal mask (FMM) or the like has a thickness that tends to gradually decrease with decreasing distance to an end portion, and has a top surface forming a slope in an area extending greater than or equal to 1 μm and less than or equal to 10 μm from the end portion, for example; thus, such an organic film has a shape whose top surface and side surface cannot be easily distinguished from each other.

An insulating layer 225, a resin layer 226, and a layer 228 are included between two adjacent light-emitting elements.

Between two adjacent light-emitting elements, a side surface of the organic layer 212 of one light-emitting element faces a side surface of the organic layer 212 of the other light-emitting element with the resin layer 226 between the side surfaces. The resin layer 226 is positioned between two adjacent light-emitting elements so as to fill the region between the end portions of their organic layers 212 and the region between the two organic layers 212. The resin layer 226 has a top surface with a smooth convex shape. The common layer 214 and the common electrode 213 are provided to cover the top surface of the resin layer 226.

The resin layer 226 functions as a planarization film that fills a step between two adjacent light-emitting elements. The resin layer 226 can prevent the common electrode 213 from being partitioned (or disconnected) by a step at an end portion of the organic layer 212, and the common electrode over the organic layer 212 from being insulated. The resin layer 226 can also be referred to as local filling planarization (LFP).

An insulating layer containing an organic material can be suitably used as the resin layer 226. Examples of materials used for the resin layer 226 include an acrylic resin, a polyimide resin, an epoxy resin, an imide resin, a polyamide resin, a polyimide-amide resin, a silicone resin, a siloxane resin, a benzocyclobutene-based resin, a phenol resin, and precursors of these resins. The resin layer 226 may be formed using an organic material such as polyvinyl alcohol (PVA), polyvinyl butyral, polyvinylpyrrolidone, polyethylene glycol, polyglycerin, pullulan, water-soluble cellulose, or an alcohol-soluble polyamide resin.

A photosensitive resin can also be used for the resin layer 226. A photoresist may be used for the photosensitive resin. As the photosensitive resin, a positive photosensitive material or a negative photosensitive material can be used.

The resin layer 226 may contain a material absorbing visible light. For example, the resin layer 226 itself may be made of a material absorbing visible light, or the resin layer 226 may contain a pigment absorbing visible light. For example, the resin layer 226 can be formed using a resin usable for a color filter that transmit red, blue, or green light and absorbs light of the other colors; or a resin that contains carbon black as a pigment and functions as a black matrix.

The insulating layer 225 is provided in contact with a side surface of the organic layer 212. Moreover, the insulating layer 225 is provided to cover a top end portion of the organic layer 212. Part of the insulating layer 225 is in contact with a top surface of the substrate 201.

The insulating layer 225 is positioned between the resin layer 226 and the organic layer 212 to function as a protective film for preventing the resin layer 226 from being in contact with the organic layer 212. When the organic layer 212 and the resin layer 226 are in contact with each other, the organic layer 212 might be dissolved by an organic solvent or the like used in formation of the resin layer 226. In view of this, the insulating layer 225 is provided between the organic layer 212 and the resin layer 226 as described in this embodiment to protect the side surface of the organic layer.

The insulating layer 225 can be an insulating layer containing an inorganic material. For the insulating layer 225, an inorganic insulating film such as an oxide insulating film, a nitride insulating film, an oxynitride insulating film, or a nitride oxide insulating film can be used, for example. The insulating layer 225 may have a single-layer structure or a stacked-layer structure. Examples of the oxide insulating film include a silicon oxide film, an aluminum oxide film, a magnesium oxide film, an indium-gallium-zinc oxide film, a gallium oxide film, a germanium oxide film, an yttrium oxide film, a zirconium oxide film, a lanthanum oxide film, a neodymium oxide film, a hafnium oxide film, and a tantalum oxide film. Examples of the nitride insulating film include a silicon nitride film and an aluminum nitride film. Examples of the oxynitride insulating film include a silicon oxynitride film and an aluminum oxynitride film. Examples of the nitride oxide insulating film include a silicon nitride oxide film and an aluminum nitride oxide film. In particular, when a metal oxide film such as an aluminum oxide film or a hafnium oxide film or an inorganic insulating film such as a silicon oxide film that is formed by an ALD method is used for the insulating layer 225, the insulating layer 225 has a small number of pin holes and excels in the function of protecting the EL layer.

Note that in this specification and the like, oxynitride refers to a material in which an oxygen content is higher than a nitrogen content, and nitride oxide refers to a material in which a nitrogen content is higher than an oxygen content. For example, silicon oxynitride refers to a material in which an oxygen content is higher than a nitrogen content, and silicon nitride oxide refers to a material in which a nitrogen content is higher than an oxygen content.

The insulating layer 225 can be formed by a sputtering method, a CVD method, a PLD method, an ALD method, or the like. The insulating layer 225 is preferably formed by an ALD method achieving good coverage.

Between the insulating layer 225 and the resin layer 226, a reflective film (e.g., a metal film containing one or more of silver, palladium, copper, titanium, aluminum, and the like) may be provided to reflect light emitted from the light-emitting layer. In this case, the light extraction efficiency can be increased.

Part of a protective layer (also referred to as a mask layer or a sacrificial layer) for protecting the organic layer 212 during etching of the organic layer 212 survives the etching to become the layer 228. For the layer 228, the material that can be used for the insulating layer 225 can be used. Particularly, the layer 228 and the insulating layer 225 are preferably formed with the same material, in which case an apparatus or the like for processing can be used in common.

In particular, a metal oxide film such as an aluminum oxide film or a hafnium oxide film and an inorganic insulating film such as a silicon oxide film which are formed by an ALD method have a small number of pinholes, and thus excel in the function of protecting the EL layer and are preferably used for the insulating layer 225 and the layer 228.

The protective layer 215 is provided to cover the common electrode 213.

The protective layer 215 can have, for example, a single-layer structure or a stacked-layer structure at least including an inorganic insulating film. Examples of the inorganic insulating film include an oxide film and a nitride film such as a silicon oxide film, a silicon oxynitride film, a silicon nitride oxide film, a silicon nitride film, an aluminum oxide film, an aluminum oxynitride film, and a hafnium oxide film. Alternatively, a semiconductor material or a conductive material such as indium gallium oxide, indium zinc oxide, indium tin oxide, or indium gallium zinc oxide may be used for the protective layer 215.

As the protective layer 215, a stacked film of an inorganic insulating film and an organic insulating film can be used. For example, a structure in which an organic insulating film is positioned between a pair of inorganic insulating films is preferable. Furthermore, it is preferable that the organic insulating film function as a planarization film. With this structure, the top surface of the organic insulating film can be flat, and accordingly, coverage with the inorganic insulating film over the organic insulating film is improved, leading to an improvement in barrier properties. Moreover, since the top surface of the protective layer 215 is flat, a preferable effect is obtained; when a component (e.g., a color filter, an electrode of a touch sensor, or a lens array) is provided above the protective layer 215, the component is less affected by an uneven shape caused by the lower structure.

FIG. 8C illustrates the connection portion 140 where the connection electrode 219 and the common electrode 213 are electrically connected to each other. In the connection portion 140, an opening portion is provided in the insulating layer 225 and the resin layer 226 over the connection electrode 219. In the opening portion, the connection electrode 219 and the common electrode 213 are electrically connected to each other.

Although FIG. 8C illustrates the connection portion 140 where the connection electrode 219 and the common electrode 213 are electrically connected to each other, the common electrode 213 may be provided over the connection electrode 219 with the common layer 214 therebetween. Particularly in the case where the common layer 214 includes a carrier-injection layer, for example, the common layer 214 can be formed to be thin using a material with sufficiently low electrical resistivity and thus can be in the connection portion 140 almost without causing any problem. Accordingly, the common electrode 213 and the common layer 214 can be formed using the same shielding mask, whereby manufacturing costs can be reduced.

The above is the description of the structure example of the display device.

### [Pixel Layout]

Pixel layouts different from the layout in FIG. 8A will be mainly described below. There is no particular limitation on the arrangement of the light-emitting elements (subpixels), and a variety of methods can be employed.

Examples of a top surface shape of the subpixel include polygons such as a triangle, a tetragon (including a rectangle and a square), and a pentagon; polygons with rounded corners; an ellipse; and a circle. Here, a top surface shape of the subpixel corresponds to a top surface shape of a light-emitting region of the light-emitting element.

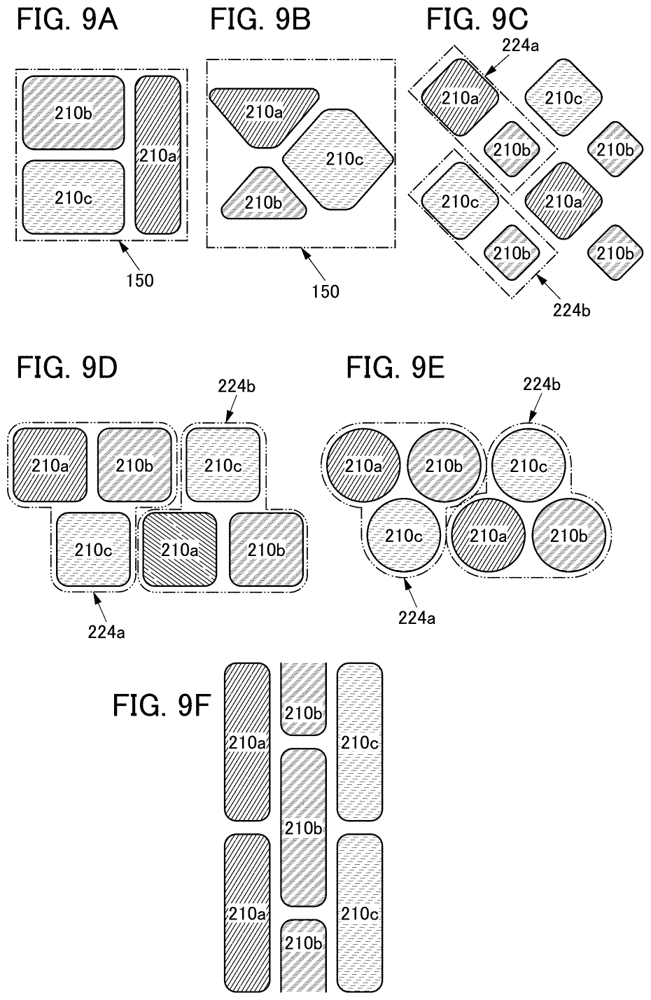

A pixel 150 illustrated in FIG. 9A employs S-stripe arrangement. The pixel 150 in FIG. 9A consists of three subpixels: light-emitting elements 210a, 210b, and 210c. For example, the light-emitting element 210a may be a blue-light-emitting element, the light-emitting element 210b may be a red-light-emitting element, and the light-emitting element 210c may be a green-light-emitting element.

The pixel 150 illustrated in FIG. 9B includes the light-emitting element 210a whose top surface has a rough trapezoidal shape with rounded corners, the light-emitting element 210b whose top surface has a rough triangle shape with rounded corners, and the light-emitting element 210c whose top surface has a rough tetragonal or rough hexagonal shape with rounded corners. The light-emitting element 210a has a larger light-emitting area than the light-emitting element 210b. In this manner, the shapes and sizes of the light-emitting elements can be determined independently. For example, the size of a light-emitting element with higher reliability can be smaller. For example, the light-emitting element 210a may be a green-light-emitting element, the light-emitting element 210b may be a red-light-emitting element, and the light-emitting element 210c may be a blue-light-emitting element.

A pixel 224a and a pixel 224b illustrated in FIG. 9C employ PenTile arrangement. The pixels 224a and 224b correspond to the pixel 240 described in the above embodiment. FIG. 9C illustrates an example in which the pixels 224a including the light-emitting elements 210a and 210b and the pixels 224b including the light-emitting elements 210b and 210c are alternately arranged. For example, the light-emitting element 210a may be a red-light-emitting element, the light-emitting element 210b may be a green-light-emitting element, and the light-emitting element 210c may be a blue-light-emitting element.

The pixels 224a and 224b illustrated in FIGS. 9D and 9E employ delta arrangement. The pixel 224a includes two light-emitting elements (the light-emitting elements 210a and 210b) in the upper row (first row) and one light-emitting element (the light-emitting element 210c) in the lower row (second row). The pixel 224b includes one light-emitting element (the light-emitting element 210c) in the upper row (first row) and two light-emitting elements (the light-emitting elements 210a and 210b) in the lower row (second row). For example, the light-emitting element 210a may be a red-light-emitting element, the light-emitting element 210b may be a green-light-emitting element, and the light-emitting element 210c may be a blue-light-emitting element.

FIG. 9D illustrates an example where the top surface of each light-emitting element has a rough tetragonal shape with rounded corners, and FIG. 9E illustrates an example where the top surface of each light-emitting element is circular.

FIG. 9F illustrates an example where light-emitting elements of different colors are arranged in a zigzag manner. Specifically, the positions of the top sides of two light-emitting elements arranged in the column direction (e.g., the light-emitting element 210a and the light-emitting element 210b or the light-emitting element 210b and the light-emitting element 210c) are not aligned in the top view. For example, the light-emitting element 210a may be a red-light-emitting element, the light-emitting element 210b may be a green-light-emitting element, and the light-emitting element 210c may be a blue-light-emitting element.

In a photolithography method, as a pattern to be formed by processing becomes finer, the influence of light diffraction becomes more difficult to ignore; therefore, the fidelity in transferring a photomask pattern by light exposure is degraded, and it becomes difficult to process a resist mask into a desired shape. Thus, a pattern with rounded corners is likely to be formed even with a rectangular photomask pattern. Consequently, a top surface of a light-emitting element may have a polygonal shape with rounded corners, an elliptical shape, a circular shape, or the like.

Furthermore, in the method for manufacturing the display panel of one embodiment of the present invention, the EL layer is processed into an island shape with the use of a resist mask. A resist film formed over the EL layer needs to be cured at a temperature lower than the upper temperature limit of the EL layer. Therefore, the resist film is insufficiently cured in some cases depending on the upper temperature limit of the material of the EL layer and the curing temperature of the resist material. An insufficiently cured resist film may have a shape different from a desired shape by processing. As a result, a top surface of the EL layer may have a polygonal shape with rounded corners, an elliptical shape, a circular shape, or the like. For example, when a resist mask with a square top surface is intended to be formed, a resist mask with a circular top surface may be formed, and the top surface of the EL layer may be circular.

To obtain a desired top surface shape of the EL layer, a technique of correcting a mask pattern in advance so that a transferred pattern agrees with a design pattern (an optical proximity correction (OPC) technique) may be used. Specifically, with the OPC technique, a pattern for correction is added to a corner portion or the like of a figure on a mask pattern.

The above is the description of the pixel layouts.

At least part of this embodiment can be implemented in combination with any of the other embodiments described in this specification as appropriate.

### Embodiment 4

In this embodiment, a structure example of a display device 400 that can be used in the display device 110 will be described.

The display device 400 of this embodiment can be used for display portions of electronic devices such as a digital camera, a digital video camera, a digital photo frame, a mobile phone, a portable game console, a smartphone, a wristwatch terminal, a tablet terminal, a portable information terminal, and an audio reproducing device, in addition to display portions of electronic devices with a relatively large screen, such as a television device, a desktop or laptop personal computer, a monitor of a computer or the like, digital signage, and a large game machine such as a pachinko machine.

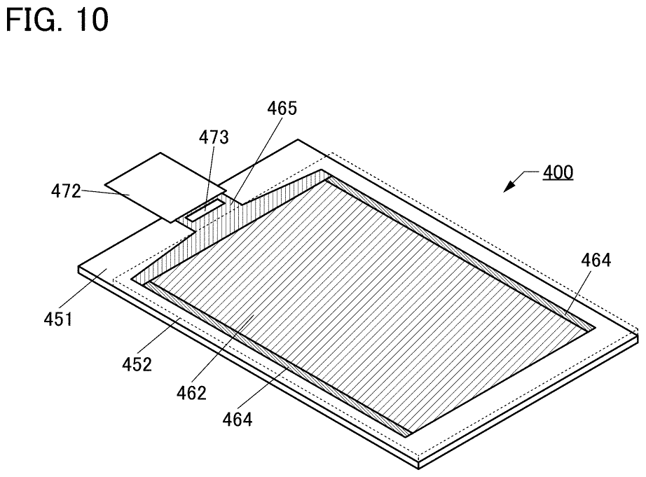

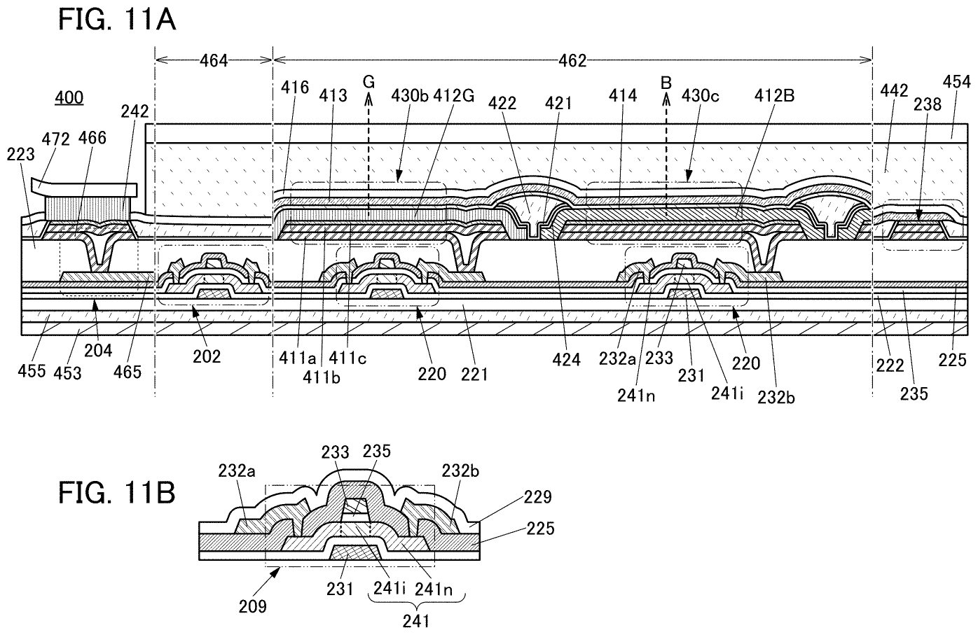

FIG. 10 is a perspective view of the display device 400, and FIG. 11A is a cross-sectional view of the display device 400.

The display device 400 has a structure where a substrate 452 and a substrate 451 are bonded to each other. In FIG. 10, the substrate 452 is denoted by a dashed line.

The display device 400 includes a display portion 462, a circuit 464, a wiring 465, and the like. FIG. 10 illustrates an example in which an IC 473 and an FPC 472 are implemented on the display device 400. Thus, the structure illustrated in FIG. 10 can be regarded as a display module including the display device 400, the IC (integrated circuit), and the FPC.

As the circuit 464, a scan line driver circuit can be used, for example.

The wiring 465 has a function of supplying a signal and power to the display portion 462 and the circuit 464. The signal and power are input to the wiring 465 from the outside through the FPC 472 or input to the wiring 465 from the IC 473.

FIG. 10 illustrates an example in which the IC 473 is provided over the substrate 451 by a chip on glass (COG) method, a chip on film (COF) method, or the like. An IC including a scan line driver circuit, a signal line driver circuit, or the like can be used as the IC 473, for example. Note that the display device 400 and the display module are not necessarily provided with an IC. The IC may be mounted on the FPC by a COF method or the like.

FIG. 11A illustrates an example of cross sections of part of a region including the FPC 472, part of the circuit 464, part of the display portion 462, and part of a region including a connection portion of the display device 400. As for the display portion 462, FIG. 11A specifically illustrates an example of a cross section of a region including a light-emitting element 430b that emits green light and a light-emitting element 430c that emits blue light.

The display device 400 illustrated in FIG. 11A includes a transistor 202, a transistor 220, the light-emitting element 430b, the light-emitting element 430c, and the like between a substrate 453 and a substrate 454.

The light-emitting element described in Embodiment 3 can be employed for the light-emitting element 430b and the light-emitting element 430c.

In the case where a pixel of the display device includes three kinds of subpixels including light-emitting elements that exhibit different colors, the three subpixels can be of three colors of red (R), green (G), and blue (B) or of three colors of yellow (Y), cyan (C), and magenta (M), for example. In the case where four subpixels are included, the four subpixels can be of four colors of R, G, B, and white (W) or of four colors of R, G, B, and Y, for example.

The substrate 454 and a protective layer 416 are bonded to each other with an adhesive layer 442. The adhesive layer 442 is provided so as to overlap with the light-emitting element 430b and the light-emitting element 430c; that is, the display device 400 employs a solid sealing structure.

Each of the light-emitting elements 430b and 430c includes a conductive layer 411a, a conductive layer 411b, and a conductive layer 411c as a pixel electrode. The conductive layer 411b reflects visible light and functions as a reflective electrode. The conductive layer 411c transmits visible light and functions as an optical adjustment layer.

The conductive layer 411a is connected to a conductive layer 232b included in the transistor 220 through an opening provided in an insulating layer 223. The transistor 220 has a function of controlling the driving of the light-emitting element.

An EL layer 412G or an EL layer 412B is provided to cover the pixel electrode. An insulating layer 421 is provided in contact with a side surface of the EL layer 412G and a side surface of the EL layer 412B, and a resin layer 422 is provided to fill a recessed portion of the insulating layer 421. A layer 424 is provided between the EL layer 412G and the insulating layer 421 and between the EL layer 412B and the insulating layer 421. A common layer 414, a common electrode 413, and the protective layer 416 are provided to cover the EL layer 412G and the EL layer 412B.

Light from the light-emitting element is emitted toward the substrate 452. For the substrate 452, a material having a high visible-light-transmitting property is preferably used.

The transistor 202 and the transistor 220 are formed over the substrate 453. These transistors can be fabricated using the same materials in the same steps.

The substrate 453 and an insulating layer 222 are bonded to each other with an adhesive layer 455.

To manufacture the display device 400, first, a formation substrate provided with the insulating layer 222, the transistors, the light-emitting elements, and the like is bonded to the substrate 454 with the adhesive layer 442. Then, the substrate 453 is bonded to a surface exposed by separation of the formation substrate, whereby the components formed over the formation substrate are transferred onto the substrate 453. The substrate 453 and the substrate 454 are preferably flexible. Accordingly, the display device 400 can be highly flexible.

As the insulating layer 222, any inorganic insulating film that can be used as an insulating layer 221 and the insulating layer 225 can be used.

A connection portion 204 is provided in a region of the substrate 453 that is not overlapped by the substrate 454. In the connection portion 204, the wiring 465 is electrically connected to the FPC 472 through a conductive layer 466 and a connection layer 242. The conductive layer 466 can be obtained by processing the same conductive film as the pixel electrode. Thus, the connection portion 204 and the FPC 472 can be electrically connected to each other through the connection layer 242.

The transistor 202 and the transistor 220 each include a conductive layer 231 functioning as a gate, the insulating layer 221 functioning as a gate insulating layer, a semiconductor layer 241 including a channel formation region 241i and a pair of low-resistance regions 241n, a conductive layer 232a connected to one of the low-resistance regions 241n, the conductive layer 232b connected to the other low-resistance region 241n, an insulating layer 235 functioning as a gate insulating layer, a conductive layer 233 functioning as a gate, and the insulating layer 225 covering the conductive layer 233. The insulating layer 221 is positioned between the conductive layer 231 and the channel formation region 241i. The insulating layer 235 is positioned between the conductive layer 233 and the channel formation region 241i.

FIG. 11A illustrates an example where the insulating layer 235 covers a top and side surfaces of the semiconductor layer. The conductive layer 232a and the conductive layer 232b are connected to the corresponding low-resistance regions 241n through openings provided in the insulating layer 235 and the insulating layer 225. One of the conductive layer 232a and the conductive layer 232b serves as a source, and the other serves as a drain.

In a transistor 209 illustrated in FIG. 11B, the insulating layer 235 overlaps with the channel formation region 241i of the semiconductor layer 241 and does not overlap with the low-resistance regions 241n. The structure illustrated in FIG. 11B is obtained by processing the insulating layer 235 with the conductive layer 233 as a mask, for example. In FIG. 11B, the insulating layer 225 is provided to cover the insulating layer 235 and the conductive layer 233, and the conductive layer 232a and the conductive layer 232b are connected to the low-resistance regions 241n through openings in the insulating layer 225. Furthermore, an insulating layer 229 covering the transistor may be provided.

There is no particular limitation on the structure of the transistors included in the display device of this embodiment. For example, a planar transistor, a staggered transistor, or an inverted staggered transistor can be used. A top-gate transistor or a bottom-gate transistor can be used. Alternatively, gates may be provided above and below a semiconductor layer where a channel is formed.

The transistors 202 and 220 employ a structure in which the semiconductor layer where a channel is formed is provided between two gates. The two gates may be connected to each other and supplied with the same signal to operate the transistor. Alternatively, the threshold voltage of the transistor may be controlled by supplying a potential for controlling the threshold voltage to one of the two gates and supplying a potential for driving to the other of the two gates.

There is no particular limitation on the crystallinity of a semiconductor material used in the semiconductor layer of the transistor, and it is possible to use an amorphous semiconductor, a single crystal semiconductor, or a semiconductor having crystallinity other than single crystal (a microcrystalline semiconductor, a polycrystalline semiconductor, or a semiconductor partly including crystal regions). It is preferable to use a single crystal semiconductor or a semiconductor having crystallinity, in which case deterioration of the transistor characteristics can be inhibited.

It is preferable that a semiconductor layer of a transistor contain a metal oxide (also referred to as an oxide semiconductor). That is, a transistor including a metal oxide in its channel formation region (hereinafter also referred to as an OS transistor) is preferably used in the display device of this embodiment.

The band gap of a metal oxide included in the semiconductor layer of the transistor is preferably 2 eV or more, further preferably 2.5 eV or more. The use of such a metal oxide having a wide band gap can reduce the off-state current of the OS transistor.

A metal oxide preferably contains at least indium or zinc, and further preferably contains indium and zinc. A metal oxide preferably contains indium, M (M is one or more of gallium, aluminum, yttrium, tin, silicon, boron, copper, vanadium, beryllium, titanium, iron, nickel, germanium, zirconium, molybdenum, lanthanum, cerium, neodymium, hafnium, tantalum, tungsten, magnesium, and cobalt), and zinc, for example.

Alternatively, a semiconductor layer of a transistor may contain silicon. Examples of silicon include amorphous silicon and crystalline silicon (e.g., low-temperature polysilicon and single crystal silicon).

The transistor included in the circuit 464 and the transistor included in the display portion 462 may have the same structure or different structures. One structure or two or more kinds of structures may be employed for a plurality of transistors included in the circuit 464. Similarly, one structure or two or more kinds of structures may be employed for a plurality of transistors included in the display portion 462.

A material through which impurities such as water and hydrogen do not easily diffuse is preferably used for at least one of the insulating layers covering the transistors. This is because such an insulating layer can function as a barrier layer. Such a structure can effectively inhibit diffusion of impurities into the transistors from the outside and increase the reliability of a display device.

An inorganic insulating film is preferably used as each of the insulating layers 221, 222, 225, 229, and 235. As the inorganic insulating film, a silicon nitride film, a silicon oxynitride film, a silicon oxide film, a silicon nitride oxide film, an aluminum oxide film, or an aluminum nitride film can be used, for example. A hafnium oxide film, an yttrium oxide film, a zirconium oxide film, a gallium oxide film, a tantalum oxide film, a magnesium oxide film, a lanthanum oxide film, a cerium oxide film, a neodymium oxide film, or the like may be used. A stack including two or more of the above inorganic insulating films may also be used.

An organic insulating film is suitable for the insulating layer 223 functioning as a planarization layer. Examples of materials that can be used for the organic insulating film include an acrylic resin, a polyimide resin, an epoxy resin, a polyamide resin, a polyimide-amide resin, a siloxane resin, a benzocyclobutene-based resin, a phenol resin, and precursors of these resins.

A variety of optical members can be arranged on the inner or outer surface of the substrate 454. Examples of optical members include a light-blocking layer, a polarizing plate, a retardation plate, a light diffusion layer (e.g., a diffusion film), an anti-reflective layer, a microlens array, and a light-condensing film. Furthermore, an antistatic film inhibiting the attachment of dust, a water repellent film suppressing the attachment of stain, a hard coat film inhibiting generation of a scratch caused by the use, an impact-absorbing layer, or the like may be arranged on the outer surface of the substrate 454.

Providing the protective layer 416 that covers the light-emitting element can prevent impurities such as water from entering the light-emitting element and increase the reliability of the light-emitting element.

FIG. 11A illustrates a connection portion 238. In the connection portion 238, the common electrode 413 is electrically connected to a wiring. FIG. 11A illustrates an example in which the wiring has the same stacked-layer structure as the pixel electrode.

For each of the substrates 453 and 454, glass, quartz, ceramic, sapphire, a resin, a metal, an alloy, a semiconductor, or the like can be used. The substrate on the side from which light from the light-emitting element is extracted is formed using a material that transmits the light. When the substrates 453 and 454 are formed using a flexible material, the flexibility of the display device can be increased. Furthermore, a polarizing plate may be used as the substrate 453 or the substrate 454.

For each of the substrates 453 and 454, any of the following can be used, for example: polyester resins such as polyethylene terephthalate (PET) and polyethylene naphthalate (PEN), a polyacrylonitrile resin, an acrylic resin, a polyimide resin, a polymethyl methacrylate resin, a polycarbonate (PC) resin, a polyethersulfone (PES) resin, polyamide resins (e.g., nylon and aramid), a polysiloxane resin, a cycloolefin resin, a polystyrene resin, a polyamide-imide resin, a polyurethane resin, a polyvinyl chloride resin, a polyvinylidene chloride resin, a polypropylene resin, a polytetrafluoroethylene (PTFE) resin, an ABS resin, and cellulose nanofiber. Glass that is thin enough to have flexibility may be used for one or both of the substrates 453 and 454.

For the adhesive layer, any of a variety of curable adhesives such as a reactive curable adhesive, a thermosetting curable adhesive, an anaerobic adhesive, and a photocurable adhesive such as an ultraviolet curable adhesive can be used. Examples of these adhesives include an epoxy resin, an acrylic resin, a silicone resin, a phenol resin, a polyimide resin, an imide resin, a polyvinyl chloride (PVC) resin, a polyvinyl butyral (PVB) resin, and an ethylene vinyl acetate (EVA) resin. In particular, a material with low moisture permeability, such as an epoxy resin, is preferred. A two-component-mixture-type resin may be used. An adhesive sheet or the like may be used.

As the connection layer 242, an anisotropic conductive film (ACF), an anisotropic conductive paste (ACP), or the like can be used.

Examples of materials for the gates, source, and drain of a transistor and conductive layers functioning as wirings and electrodes included in the display device include a metal such as aluminum, titanium, chromium, nickel, copper, yttrium, zirconium, molybdenum, silver, tantalum, and tungsten, and an alloy containing any of these metals as its main component. A single-layer structure or a stacked-layer structure including a film containing any of these materials can be used.

As a light-transmitting conductive material, a conductive oxide such as indium oxide, indium tin oxide, indium zinc oxide, zinc oxide, or zinc oxide containing gallium, or graphene can be used. It is also possible to use a metal material such as gold, silver, platinum, magnesium, nickel, tungsten, chromium, molybdenum, iron, cobalt, copper, palladium, or titanium; or an alloy material containing any of these metal materials. Alternatively, a nitride of the metal material (e.g., titanium nitride) or the like may be used. Note that in the case of using the metal material or the alloy material (or the nitride thereof), the thickness is preferably set small enough to transmit light. Alternatively, a stacked film of any of the above materials can be used for a conductive layer. For example, a stacked film of indium tin oxide and an alloy of silver and magnesium is preferably used, in which case the conductivity can be increased. These materials can also be used for conductive layers such as wirings and electrodes included in the display device, and conductive layers (e.g., a conductive layer functioning as a pixel electrode or a common electrode) included in a light-emitting element.

Examples of insulating materials that can be used for the insulating layers include a resin such as an acrylic resin and an epoxy resin, and an inorganic insulating material such as silicon oxide, silicon oxynitride, silicon nitride oxide, silicon nitride, and aluminum oxide.

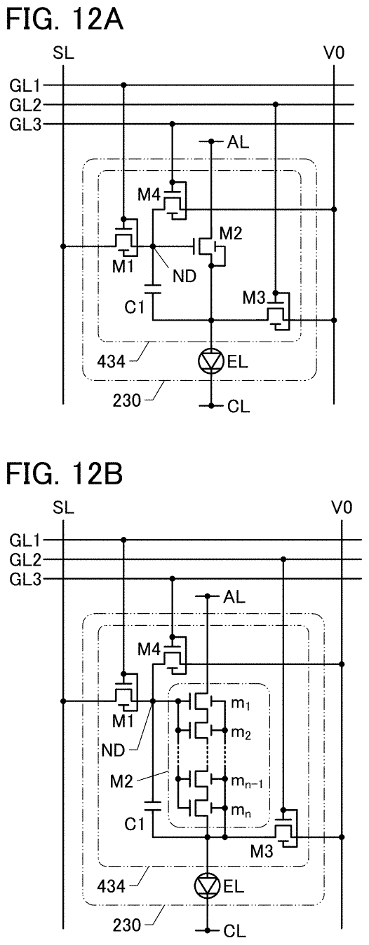

FIGS. 12A and 12B illustrate examples of a circuit configuration that can be used for the subpixel 230. The subpixel 230 illustrated in FIG. 12A includes a pixel circuit 434 and a light-emitting element EL.

As the light-emitting element EL, it is possible to use any of a variety of display elements such as an EL element (e.g., an EL element containing an organic material and an inorganic material, an organic EL element, and an inorganic EL element), an LED (e.g., a white LED, a red LED, a green LED, and a blue LED), a micro LED, a quantum-dot light-emitting diode (QLED), and an electron emitter device. For example, the light-emitting element 210 described in the above embodiment can be used as the light-emitting element EL.

The pixel circuit 434 includes a transistor M1, a transistor M2, a transistor M3, a transistor M4, and a capacitor C1. To the subpixel 230 illustrated in FIG. 12A, a wiring GL1, a wiring GL2, a wiring GL3, a wiring SL, a wiring AL, and a wiring CL are electrically connected.

The wirings GL1, GL2, and GL3 are supplied with gate signals. The wiring SL is supplied with a source signal. The wirings AL and CL are each supplied with a constant potential. In the light-emitting element EL, the anode side can have a high potential and the cathode side can have a lower potential than the anode side.

A gate of the transistor M1 is electrically connected to the wiring GL1, one of a source and a drain of the transistor M1 is electrically connected to the wiring SL, and the other of the source and the drain of the transistor M1 is electrically connected to one electrode of the capacitor C1 and a gate of the transistor M2.

A region where the other of the source and the drain of the transistor M1, the gate of the transistor M2, and the one electrode of the capacitor C1 are electrically connected to each other is referred to as a node ND. The transistor M1 functions as a switch for controlling selection and non-selection of a pixel subjected to writing of a video signal to the node ND. Thus, the transistor M1 can be referred to as a selection transistor.

The capacitor C1 functions as a storage capacitor. The other electrode of the capacitor C1 is electrically connected to the anode of the light-emitting element EL. Note that the capacitor C1 does not have to be provided if not needed.

One of a source and a drain of the transistor M2 is electrically connected to the wiring AL. The other of the source and the drain of the transistor M2 is electrically connected to the anode of the light-emitting element EL. The wiring CL is electrically connected to the cathode of the light-emitting element EL.

The transistor M2 has a function of controlling the amount of current flowing through the light-emitting element EL in accordance with the potential of the node ND. Thus, the transistor M2 can be referred to as a driving transistor.

A gate of the transistor M3 is electrically connected to the wiring GL2, and one of a source and a drain of the transistor M3 is electrically connected to the anode of the light-emitting element EL. The other of the source and the drain of the transistor M3 is electrically connected to a wiring V0.

A gate of the transistor M4 is electrically connected to the wiring GL3, and one of a source and a drain of the transistor M4 is electrically connected to the gate of the transistor M2. The other of the source and the drain of the transistor M4 is electrically connected to the wiring V0.

When the transistors M3 and M4 are turned on in the same period, the potentials of the source and gate of the transistor M2 become the same, whereby the transistor M2 can be turned off. Thus, a current flowing to the light-emitting element EL can be blocked forcibly. Such a pixel circuit is suitable for the case of using a display method in which a display period and an off period are alternately provided. The wiring V0 is supplied with 0 V, for example.

In FIG. 12A, each of the transistors M1, M2, M3, and M4 is a transistor including a back gate. In each of the transistors M1, M3, and M4, the gate and the back gate are electrically connected to each other. The back gate of the transistor M2 is electrically connected to the anode of the light-emitting element EL.

FIG. 12B shows a variation example of the circuit configuration illustrated in FIG. 12A. In FIG. 12B, as the transistor M2, n transistors m (n is an integer of 2 or more) are connected in series. Gates of the n transistors m (transistors m₁ to mₙ) are electrically connected to the node ND. Back gates of the n transistors m are electrically connected to the anode of the light-emitting element EL. Thus, the n transistors m function substantially as one transistor. The transistor M2 in FIG. 12B is a multi-gate transistor including n gates.

During normal image display, the transistor M2 operates in a saturation region. In general, when a transistor operates in a saturation region with its gate voltage constant, a change of the drain current (Id) relative to a change of the drain voltage (Vd) is preferably as small as possible. A small change of Id relative to a change of Vd means favorable saturation characteristics.

In a multi-gate transistor, a larger number n of gates results in more favorable saturation characteristics. That is, increasing the number of transistors in series, which are used as the transistor M2, achieves more favorable saturation characteristics. Note that n representing the number of gates and the number of transistors in series is preferably larger than or equal to 2, further preferably larger than or equal to 5.

At least part of this embodiment can be implemented in combination with any of the other embodiments described in this specification as appropriate.

### Embodiment 5

In this embodiment, a light-emitting element (also referred to as light-emitting device) that can be used in the display device 110 will be described.

In this specification and the like, a device formed using a metal mask or a fine metal mask (FMM) may be referred to as a device having a metal mask (MM) structure. In this specification and the like, a device formed without using a metal mask or an FMM may be referred to as a device having a metal maskless (MML) structure.

In this specification and the like, a structure in which light-emitting layers in light-emitting devices of different colors (here, blue (B), green (G), and red (R)) are separately formed or separately patterned may be referred to as a side-by-side (SBS) structure. In this specification and the like, a light-emitting device capable of emitting white light may be referred to as a white-light-emitting device. Note that a combination of white-light-emitting devices with coloring layers (e.g., color filters) enables a full-color display apparatus.

Structures of light-emitting devices can be classified roughly into a single structure and a tandem structure. A light-emitting device having a single structure includes one light-emitting unit between a pair of electrodes. The light-emitting unit includes one or more light-emitting layers. To obtain white light emission by using two light-emitting layers, the two light-emitting layers are selected such that emission colors of the light-emitting layers are complementary colors. For example, when emission colors of a first light-emitting layer and a second light-emitting layer are complementary colors, a light-emitting device can be configured to emit white light as a whole. To obtain white light emission by using three or more light-emitting layers, the light-emitting device is configured to emit white light as a whole by combining emission colors of the three or more light-emitting layers.

A light-emitting device having a tandem structure includes a plurality of light-emitting units between a pair of electrodes. Each light-emitting unit includes one or more light-emitting layers. When light-emitting layers that emit light of the same color are used in each light-emitting unit, luminance per predetermined current can be increased, and the light-emitting device can have higher reliability than that with a single structure. To obtain white light emission with a tandem structure, the light-emitting device is configured to obtain white light emission by combining light from light-emitting layers of a plurality of light-emitting units. Note that a combination of emission colors for obtaining white light emission is similar to that for a single structure. In the light-emitting device with a tandem structure, it is preferable that an intermediate layer such as a charge-generation layer be provided between the plurality of light-emitting units.

When a white-light-emitting device and a light-emitting device with a SBS structure are compared to each other, the latter can have lower power consumption than the former. Meanwhile, the white-light-emitting device is preferable in terms of lower manufacturing cost and higher manufacturing yield because the manufacturing process of the white-light-emitting device is simpler than that of the light-emitting device with the SBS structure.

### <Structure Example of Light-Emitting Device>

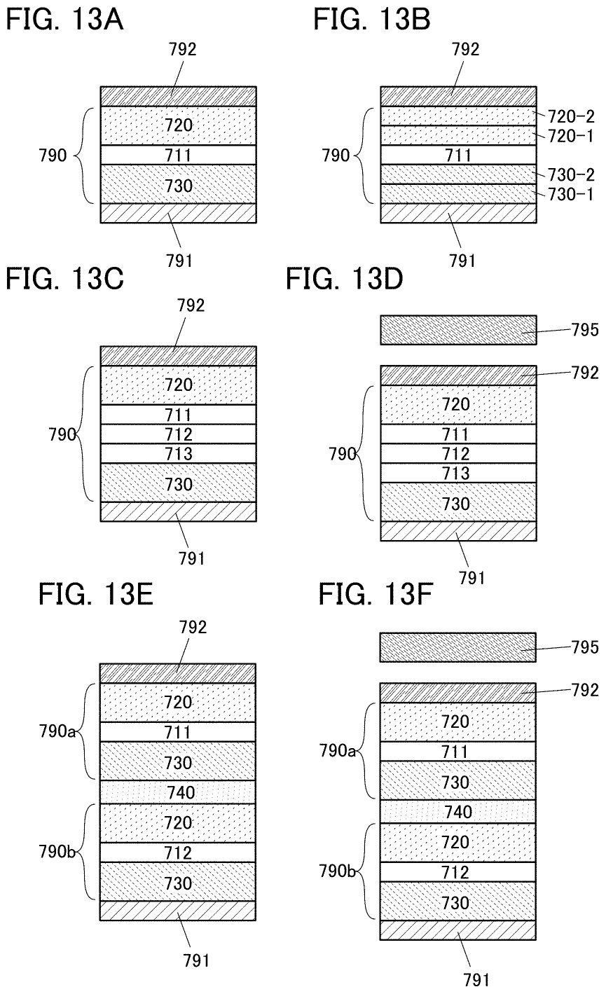

As illustrated in FIG. 13A, the light-emitting device includes an EL layer 790 between a pair of electrodes (a lower electrode 791 and an upper electrode 792). The EL layer 790 can be formed of a plurality of layers such as a layer 720, a light-emitting layer 711, and a layer 730. The layer 720 can include, for example, a layer containing a substance with a high electron-injection property (an electron-injection layer) and a layer containing a substance with a high electron-transport property (an electron-transport layer). The light-emitting layer 711 contains a light-emitting compound, for example. The layer 730 can include, for example, a layer containing a substance with a high hole-injection property (a hole-injection layer) and a layer containing a substance with a high hole-transport property (a hole-transport layer).

The structure including the layer 720, the light-emitting layer 711, and the layer 730, which is provided between a pair of electrodes, can function as a single light-emitting unit, and the structure in FIG. 13A is referred to as a single structure in this specification.

Specifically, the light-emitting device illustrated in FIG. 13B includes, over the lower electrode 791, a layer 730-1, a layer 730-2, the light-emitting layer 711, a layer 720-1, a layer 720-2, and the upper electrode 792. For example, when the lower electrode 791 functions as an anode and the upper electrode 792 functions as a cathode, the layer 730-1 functions as a hole-injection layer, the layer 730-2 functions as a hole-transport layer, the layer 720-1 functions as an electron-transport layer, and the layer 720-2 functions as an electron-injection layer. Meanwhile, when the lower electrode 791 functions as the cathode and the upper electrode 792 functions as the anode, the layer 730-1 functions as an electron-injection layer, the layer 730-2 functions as an electron-transport layer, the layer 720-1 functions as a hole-transport layer, and the layer 720-2 functions as a hole-injection layer. With such a layered structure, carriers can be efficiently injected to the light-emitting layer 711, and the efficiency of the recombination of carriers in the light-emitting layer 711 can be enhanced.

Note that structures in which a plurality of light-emitting layers (light-emitting layers 711, 712, and 713) are provided between the layer 720 and the layer 730 as illustrated in FIGS. 13C and 13D are variations of the single structure.

Structures in which a plurality of light-emitting units (EL layers 790a and 790b) are connected in series with an intermediate layer (charge-generation layer) 740 therebetween as illustrated in FIGS. 13E and 13F are referred to as a tandem structure in this specification. A tandem structure may be referred to as a stack structure. The tandem structure enables a light-emitting device capable of high-luminance light emission.

In FIG. 13C, light-emitting materials that emit light of the same color, or moreover, the same light-emitting material may be used for the light-emitting layers 711, 712, and 713. The stacked light-emitting layers can increase the luminance.

Alternatively, different light-emitting materials may be used for the light-emitting layers 711, 712, and 713. White light is obtained when the light-emitting layers 711, 712, and 713 emit light of complementary colors. FIG. 13D illustrates an example in which a coloring layer 795 functioning as a color filter is provided. When white light passes through the color filter, light of a desired color can be obtained.

In FIG. 13E, light-emitting materials that emit light of the same color may be used for the light-emitting layers 711 and 712. Alternatively, light-emitting materials that emit light of different colors may be used for the light-emitting layers 711 and 712. White light is obtained when the light-emitting layers 711 and 712 emit light of complementary colors. FIG. 13F illustrates an example in which the coloring layer 795 is further provided.

In FIGS. 13C to 13F, the layer 720 and the layer 730 may each have a layered structure of two or more layers as in FIG. 13B.

In FIG. 13D, light-emitting materials that emit light of the same color may be used for the light-emitting layers 711, 712, and 713. Similarly, in FIG. 13F, light-emitting materials that emit light of the same color may be used for the light-emitting layers 711 and 712. Here, when a color conversion layer is used instead of the coloring layer 795, light of a desired color different from the emission color of the light-emitting material can be obtained. For example, a blue-light-emitting material is used for each light-emitting layer and blue light passes through the color conversion layer, whereby light with a wavelength longer than that of blue light (e.g., red light or green light) can be obtained. For the color conversion layer, a fluorescent material, a phosphorescent material, quantum dots, or the like can be used.

The emission color of the light-emitting device can be red, green, blue, cyan, magenta, yellow, white, or the like depending on the material of the EL layer 790. When the light-emitting device has a microcavity structure, the color purity can be further increased.

In the light-emitting device that emits white light, a light-emitting layer may contain two or more kinds of light-emitting substances, or two or more light-emitting layers containing different light-emitting substances may be stacked. In such a case, the light-emitting substances are preferably selected such that the light-emitting substances emit light of complementary colors.

Here, a more specific structure example of the light-emitting device will be described.

The light-emitting device includes at least a light-emitting layer. In addition to the light-emitting layer, the light-emitting device may further include a layer containing any of a substance with a high hole-injection property, a substance with a high hole-transport property, a hole-blocking material, a substance with a high electron-transport property, a substance with a high electron-injection property, an electron-blocking material, a substance with a bipolar property (a substance with a high electron- and hole-transport property), and the like.

Either a low molecular compound or a high molecular compound can be used in the light-emitting device, and an inorganic compound may also be included. Each layer included in the light-emitting device can be formed, for example, by an evaporation method (including a vacuum evaporation method), a transfer method, a printing method, an inkjet method, or a coating method.

For example, the light-emitting device can include one or more of a hole-injection layer, a hole-transport layer, a hole-blocking layer, an electron-blocking layer, an electron-transport layer, and an electron-injection layer.

The hole-injection layer injects holes from the anode to the hole-transport layer and contains a material with a high hole-injection property. Examples of a material with a high hole-injection property include an aromatic amine compound and a composite material containing a hole-transport material and an acceptor material (electron-accepting material).

The hole-transport layer transports holes injected from the anode by the hole-injection layer, to the light-emitting layer. The hole-transport layer contains a hole-transport material. The hole-transport material preferably has a hole mobility higher than or equal to 1×10⁻⁶ cm²/Vs. Note that other substances can also be used as long as the substances have a hole-transport property higher than an electron-transport property. As the hole-transport material, materials having a high hole-transport property, such as a π-electron rich heteroaromatic compound (e.g., a carbazole derivative, a thiophene derivative, and a furan derivative) and an aromatic amine (a compound having an aromatic amine skeleton), are preferred.

The electron-transport layer transports electrons injected from the cathode by the electron-injection layer, to the light-emitting layer. The electron-transport layer contains an electron-transport material. The electron-transport material preferably has an electron mobility higher than or equal to 1×10⁻⁶ cm²/Vs. Note that other substances can also be used as long as the substances have an electron-transport property higher than a hole-transport property. As the electron-transport material, any of the following materials having a high electron-transport property can be used, for example: a metal complex having a quinoline skeleton, a metal complex having a benzoquinoline skeleton, a metal complex having an oxazole skeleton, a metal complex having a thiazole skeleton, an oxadiazole derivative, a triazole derivative, an imidazole derivative, an oxazole derivative, a thiazole derivative, a phenanthroline derivative, a quinoline derivative having a quinoline ligand, a benzoquinoline derivative, a quinoxaline derivative, a dibenzoquinoxaline derivative, a pyridine derivative, a bipyridine derivative, a pyrimidine derivative, and a π-electron deficient heteroaromatic compound such as a nitrogen-containing heteroaromatic compound.

The electron-injection layer injects electrons from the cathode to the electron-transport layer and contains a material with a high electron-injection property. As the material with a high electron-injection property, an alkali metal, an alkaline earth metal, or a compound thereof can be used. As the material with a high electron-injection property, a composite material containing an electron-transport material and a donor material (electron-donating material) can also be used.

The electron-injection layer can be formed using an alkali metal, an alkaline earth metal, or a compound thereof, such as lithium, cesium, ytterbium, lithium fluoride (LiF), cesium fluoride (CsF), calcium fluoride (CaF₂), 8-(quinolinolato)lithium (abbreviation: Liq), 2-(2-pyridyl)phenolatolithium (abbreviation: LiPP), 2-(2-pyridyl)-3-pyridinolatolithium (abbreviation: LiPPy), 4-phenyl-2-(2-pyridyl)phenolatolithium (abbreviation: LiPPP), lithium oxide (LiOₓ), or cesium carbonate, for example. The electron-injection layer may have a stacked-layer structure of two or more layers. In the stacked-layer structure, for example, lithium fluoride can be used for the first layer and ytterbium can be used for the second layer.

Alternatively, the electron-injection layer may be formed using an electron-transport material. For example, a compound having an unshared electron pair and an electron deficient heteroaromatic ring can be used as the electron-transport material. Specifically, it is possible to use a compound having at least one of a pyridine ring, a diazine ring (a pyrimidine ring, a pyrazine ring, or a pyridazine ring), and a triazine ring.

Note that the lowest unoccupied molecular orbital (LUMO) level of the organic compound having an unshared electron pair is preferably greater than or equal to −3.6 eV and less than or equal to −2.3 eV. In general, the highest occupied molecular orbital (HOMO) level and the LUMO level of the organic compound can be estimated by cyclic voltammetry (CV), photoelectron spectroscopy, optical absorption spectroscopy, inverse photoelectron spectroscopy, or the like.

For example, 4,7-diphenyl-1,10-phenanthroline (abbreviation: BPhen), 2,9-di(naphthalen-2-yl)-4,7-diphenyl-1,10-phenanthroline (abbreviation: NBPhen), diquinoxalino[2,3-a: 2′,3′-c]phenazine (abbreviation: HATNA), 2,4,6-tris[3′-(pyridin-3-yl)biphenyl-3-yl]-1,3,5-triazine (abbreviation: TmPPPyTz), or the like can be used as the organic compound having an unshared electron pair. Note that NBPhen has a higher glass transition point (Tg) than BPhen and thus has high heat resistance.

The light-emitting layer contains a light-emitting substance. The light-emitting layer can contain one or more kinds of light-emitting substances. As the light-emitting substance, a substance whose emission color is blue, violet, bluish violet, green, yellowish green, yellow, orange, red, or the like is appropriately used. Alternatively, as the light-emitting substance, a substance that emits near-infrared light can be used.

Examples of the light-emitting substance include a fluorescent material, a phosphorescent material, a TADF material, and a quantum dot material.

Examples of a fluorescent material include a pyrene derivative, an anthracene derivative, a triphenylene derivative, a fluorene derivative, a carbazole derivative, a dibenzothiophene derivative, a dibenzofuran derivative, a dibenzoquinoxaline derivative, a quinoxaline derivative, a pyridine derivative, a pyrimidine derivative, a phenanthrene derivative, and a naphthalene derivative.

Examples of a phosphorescent material include an organometallic complex (particularly an iridium complex) having a 4H-triazole skeleton, a 1H-triazole skeleton, an imidazole skeleton, a pyrimidine skeleton, a pyrazine skeleton, or a pyridine skeleton; an organometallic complex (particularly an iridium complex) having a phenylpyridine derivative including an electron-withdrawing group as a ligand; a platinum complex; and a rare earth metal complex.

The light-emitting layer may contain one or more kinds of organic compounds (e.g., a host material or an assist material) in addition to the light-emitting substance (guest material). As one or more kinds of organic compounds, one or both of the hole-transport material and the electron-transport material can be used. Alternatively, as one or more kinds of organic compounds, a bipolar material or a TADF material may be used.

The light-emitting layer preferably includes a phosphorescent material and a combination of a hole-transport material and an electron-transport material that easily forms an exciplex, for example. With such a structure, light emission can be efficiently obtained by exciplex—triplet energy transfer (ExTET), which is energy transfer from the exciplex to the light-emitting substance (phosphorescent material). When a combination of materials is selected so as to form an exciplex that emits light whose wavelength overlaps with the wavelength of a lowest-energy-side absorption band of the light-emitting substance, energy can be transferred smoothly and light emission can be obtained efficiently. With the above structure, high efficiency, low-voltage driving, and a long lifetime of a light-emitting device can be achieved at the same time.

At least part of this embodiment can be implemented in combination with any of the other embodiments described in this specification as appropriate.

### Example

This example will describe results of correcting luminance variations among the subpixels 230R included in the display portion 111 by using the image correction system and the image correction method described in the above embodiment. Specifically, the description will be made on image correction results in the case where an 8-bit correction video signal AS has a gray level of 192.

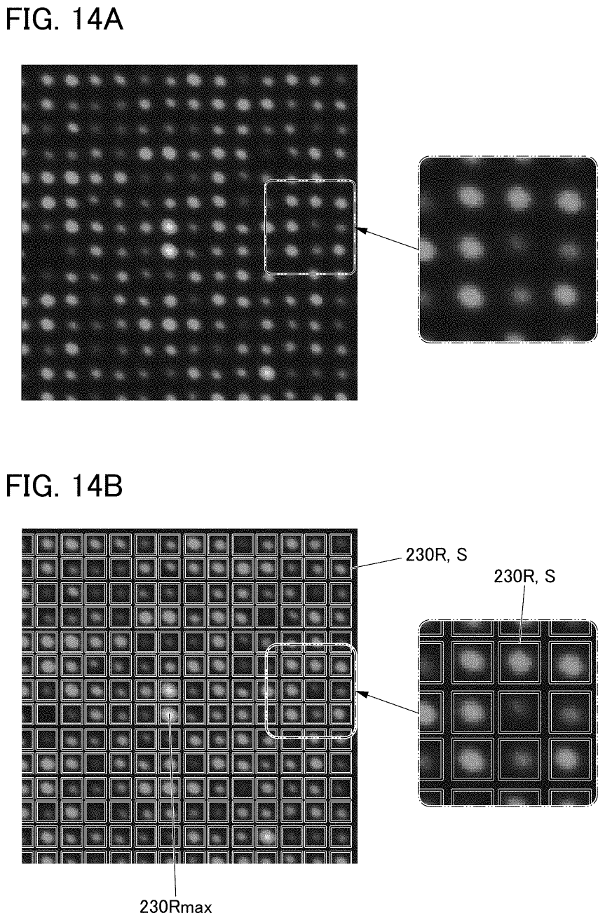

First, the correction video signal AS with a gray level of 192 was supplied to all the subpixels 230R in the display portion 111 so that all the subpixels 230R emitted light. Next, an image of the display portion 111 was captured by the imaging device 121, whereby imaging data including luminance distribution was obtained (see Step S501). FIG. 14A shows a visualized image of the luminance distribution obtained by visualizing part of the imaging data.

Then, the positions and the areas S of all the subpixels 230R in the imaging data were set (see Step S502). To easily set the position and the area S of the subpixel 230R in the imaging data, adjustment for reducing inclination and distortion of the luminance distribution in the imaging data was performed in advance. Note that a given size was used as the area S, because the area S can be any value as long as all the subpixels 230R have the same area S. FIG. 14B shows that rectangles each indicating the set position and the set area S of the subpixel 230R are superimposed on the visualized image in FIG. 14A.

Next, the integral of luminance in the area S was calculated for all the subpixels 230R in the imaging data. That is, the integral indicates a luminous intensity per subpixel 230R. Here, the luminous intensity of a subpixel 230R with the highest luminous intensity (a subpixel 230Rmax) was used as a correction standard (see Step S503 and Step S504).

Subsequently, the correction data CVR was generated for each of the subpixels 230R such that the luminous intensities of all the subpixels 230R in the imaging data were equal to the correction standard (see Step S505).

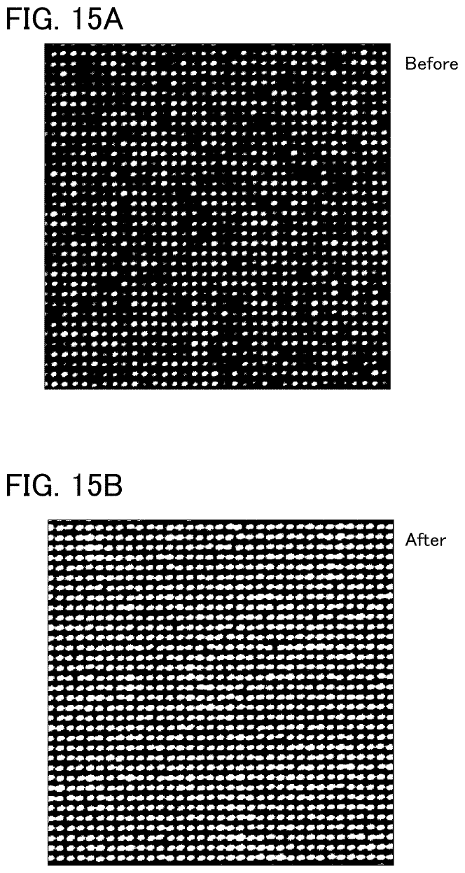

FIG. 15A shows part of a visualized image (Before) obtained by capturing an image based on the correction video signals AS that have not yet been corrected with the correction data CVR. FIG. 15B shows part of a visualized image (After) obtained by capturing an image based on the correction video signals AS that have been corrected with the correction data CVR. It is apparent that correcting the correction video signals AS for each subpixel 230R reduces luminance variations in the entire display portion 111.

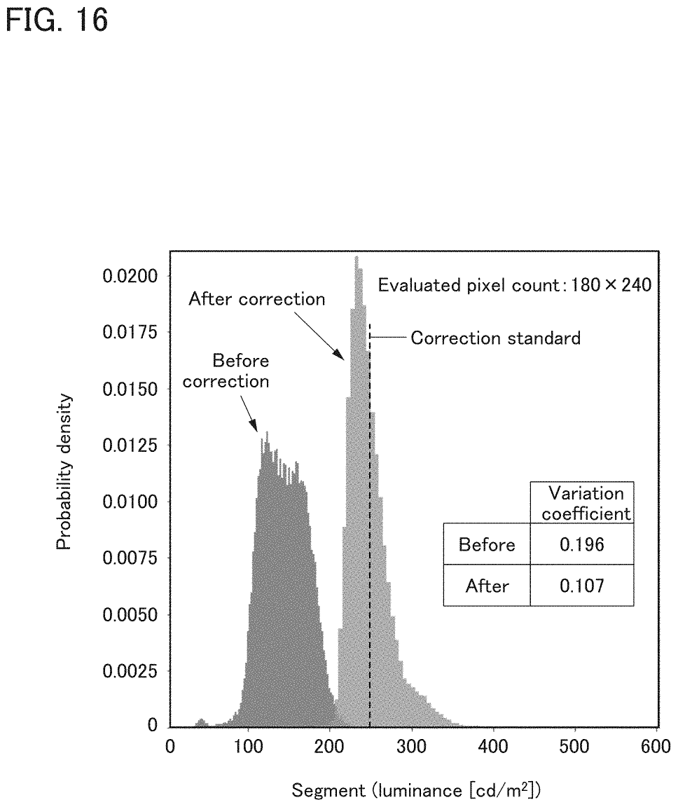

FIG. 16 is a histogram showing luminance variations before and after correction using the correction data CVR. The number of pixels evaluated in FIG. 16 is 180×240. The horizontal axis in FIG. 16 represents luminance calculated by standardizing the luminous intensity of each pixel by the area S and is divided into segments with a certain range. The vertical axis in FIG. 16 represents a probability density and shows the proportion of pixels included in one segment to all the pixels. FIG. 16 also shows the correction standard and a coefficient of variation before and after the correction.

It is apparent from FIG. 16 that the segment with a high probability density almost agrees with the correction standard in the histogram after the correction. Moreover, the coefficient of variation after the correction is smaller than that before the correction, demonstrating that luminance variations are reduced by the image correction method according to one embodiment of the present invention.

This application is based on Japanese Patent Application Serial No. 2021-143124 filed with Japan Patent Office on Sep. 2, 2021, the entire contents of which are hereby incorporated by reference.

What is claimed is:

1. An image correction method for a display device including a plurality of pixels arranged in a matrix, comprising the steps of:
obtaining luminance distribution of an image displayed with a first gray level;
determining a position and an area of each of the plurality of pixels, by using the luminance distribution;
calculating a luminous intensity of each of the plurality of pixels, by using the luminance distribution;
determining a correction standard by using the luminous intensity of each of the plurality of pixels;
generating correction data by using the correction standard and the luminous intensities of the pixels;
storing the correction data in a memory device; and
correcting a video signal to be supplied to each of the plurality of pixels, by using the correction data stored in the memory device.

2. The image correction method according to claim 1,
wherein the correction standard is a maximum value, an average value, or a median value of the luminous intensities of the plurality of pixels.

3. An image correction system comprising:
an imaging device;
a first arithmetic device;
a display portion including a plurality of pixels; and
a second arithmetic device,
wherein the imaging device is configured to obtain luminance distribution by capturing a first-gray-level image displayed on the display portion,
wherein the first arithmetic device is configured to calculate a luminous intensity of each of the plurality of pixels by using the luminance distribution, calculate a correction standard by using the luminance distribution, and calculate correction data for each of the plurality of pixels by using the luminous intensity of each of the plurality of pixels and the correction standard, and
wherein the second arithmetic device is configured to correct a video signal for displaying an image on the display portion, by using the correction data.

4. The image correction system according to claim 3,
wherein the correction standard is a maximum value, an average value, or a median value of the luminous intensities of the plurality of pixels.

5. The image correction system according to claim 3, further comprising:
a first memory device and a second memory device,
wherein the first memory device is configured to store the luminance distribution, and
wherein the second memory device is configured to store the correction data.

6. An image correction system comprising:
an imaging device;
a first arithmetic device;
a display portion including a plurality of first pixels that emit first light, a plurality of second pixels that emit second light, and a plurality of third pixels that emit third light; and
a second arithmetic device,
wherein the imaging device is configured to obtain luminance distribution by capturing a first-gray-level image displayed on the display portion,
wherein the first arithmetic device is configured to calculate a luminous intensity of each of the first pixels, a first correction standard, a luminous intensity of each of the second pixels, a second correction standard, a luminous intensity of each of the third pixels, and a third correction standard, by using the luminance distribution,
wherein the first arithmetic device is configured to calculate first correction data for each of the first pixels by using the luminous intensity of each of the first pixels and the first correction standard, calculate second correction data for each of the second pixels by using the luminous intensity of each of the second pixels and the second correction standard, and calculate third correction data for each of the third pixels by using the luminous intensity of each of the third pixels and the third correction standard, and
wherein the second arithmetic device is configured to correct a video signal for displaying an image on the display portion, by using the first correction data, the second correction data, and the third correction data.

7. The image correction system according to claim 6,
wherein the first correction standard is a maximum value, an average value, or a median value of the luminous intensities of the first pixels,
wherein the second correction standard is a maximum value, an average value, or a median value of the luminous intensities of the second pixels, and
wherein the third correction standard is a maximum value, an average value, or a median value of the luminous intensities of the third pixels.

8. The image correction system according to claim 6, further comprising:
a first memory device and a second memory device,
wherein the first memory device is configured to store the luminance distribution, and
wherein the second memory device is configured to store the first correction data, the second correction data, and the third correction data.

9. The image correction system according to claim 6,
wherein the first light is red light, the second light is green light, and the third light is blue light.

10. The image correction system according to claim 6,
wherein the first arithmetic device is configured to adjust white balance by adjusting values of the first correction data, the second correction data, and the third correction data by using color temperature data.
